(19) United States
(12) Patent Application Publication
(10) Pub. No.: US 2025/0217198 A1
(43) Pub. Date: Jul. 3, 2025

(54) COMPLEX COMPUTING NETWORK FOR CONTROLLING COMPUTING OPERATIONS BASED ON A COMPUTING LOAD

(71) Applicant: Lilly R. Talavera, Allen, TX (US)

(72) Inventor: Lilly R. Talavera, Allen, TX (US)

(21) Appl. No.: 18/991,687

(22) Filed: Dec. 22, 2024

Related U.S. Application Data
(63) Continuation-in-part of application No. 18/922,360, filed on Oct. 21, 2024.
Application No. 18/922,360 is a continuation-in-part of application No. 18/402,659, filed on Jan. 2, 2024, now Pat. No. 12,124,881.
Application No. 18/922,360 is a continuation-in-part of application No. 18/916,544, filed on Oct. 15, 2024.
Application No. 18/916,544 is a continuation-in-part of application No. 18/402,659, filed on Jan. 2, 2024, now Pat. No. 12,124,881.
(60) Provisional application No. 63/613,049, filed on Dec. 20, 2023.
(60) Provisional application No. 63/436,582, filed on Dec. 31, 2022.
(60) Provisional application No. 63/461,314, filed on Apr. 23, 2023.
(60) Provisional application No. 63/543,101, filed on Oct. 8, 2023.
(60) Provisional application No. 63/546,235, filed on Oct. 29, 2023.
(60) Provisional application No. 63/617,051, filed on Jan. 2, 2024.
(60) Provisional application No. 63/544,227, filed on Oct. 15, 2023.
(60) Provisional application No. 63/617,050, filed on Jan. 2, 2024.
(60) Provisional application No. 63/617,056, filed on Jan. 2, 2024.

(51) Int. Cl. G06F 9/50

(52) U.S. Cl. CPC G06F 9/5027

(57) ABSTRACT

This disclosure is directed to intelligent synchronization of computing users, and associated timing data, based on parameters or data received from computing systems connected via wireless, satellite, wire-based, optical-fiber based, etc., computing networks. In some embodiments, a method comprises adjusting, using a resource allocator, one or more computing operations executable in the computing network, based on at least one of: a computing load associated with the computing network, an available storage or memory associated with the computing network, a number or type of users associated with the computing network or online on the computing network, or a number or type of operations being executed or to be executed by the computing network.

### CROSS-REFERENCE TO RELATED APPLICATIONS

This application is a continuation-in-part of U.S. application Ser. No. 18/922,360, filed on Oct. 21, 2024, which is a continuation-in-part of U.S. application Ser. No. 18/402,659, filed on Jan. 2, 2024, now issued as U.S. Pat. No. 12,124,881, which claims the benefit of U.S. Provisional Application No. 63/436,582, filed on Dec. 31, 2022, U.S. Provisional Application No. 63/461,314, filed on Apr. 23, 2023, U.S. Provisional Application No. 63/543,101, filed on Oct. 8, 2023, and U.S. Provisional Application No. 63/546,235, filed on Oct. 29, 2023, all of which are incorporated by reference into this application for all purposes. U.S. application Ser. No. 18/922,360 is also a continuation-in-part of U.S. application Ser. No. 18/916,544, filed on Oct. 15, 2024, which claims the benefit of U.S. Provisional Application No. 63/617,051, filed on Jan. 2, 2024 and U.S. Provisional Application No. 63/544,227, filed on Oct. 15, 2023, all of which are incorporated by reference into this application for all purposes. U.S. application Ser. No. 18/916,544, filed on Oct. 15, 2024, is a continuation-in-part of U.S. application Ser. No. 18/402,659, filed on Jan. 2, 2024, now issued as U.S. Pat. No. 12,124,881, all of which are incorporated by reference into this application for all purposes.

This application also claims the benefit of U.S. Provisional Application No. 63/613,049, filed on Dec. 20, 2023, U.S. Provisional Application No. 63/617,050, filed on Jan. 2, 2024, and U.S. Provisional Application No. 63/617,056, filed on Jan. 2, 2024, all of which are incorporated by reference into this application for all purposes.

### TECHNICAL FIELD

This disclosure is directed to computing applications.

### BACKGROUND

There is a need to improve the speed and efficiency of synchronizing computing device users and their timing data in complex computing networks. There is a need for improved network communication and improved controlling of access to database records. There is a need for improved computing applications across various fields.

### BRIEF DESCRIPTION OF THE DRAWINGS

FIG. 1A is a network diagram for executing any methods described herein, in accordance with some embodiments of the disclosure;

FIG. 1B is a system diagram for executing any methods described herein, in accordance with some embodiments of the disclosure;

All of these drawings are illustrations of certain embodiments. The scope of the Claims is not limited to the specific embodiments illustrated in the drawings and described herein.

### DETAILED DESCRIPTION OF THE EMBODIMENTS

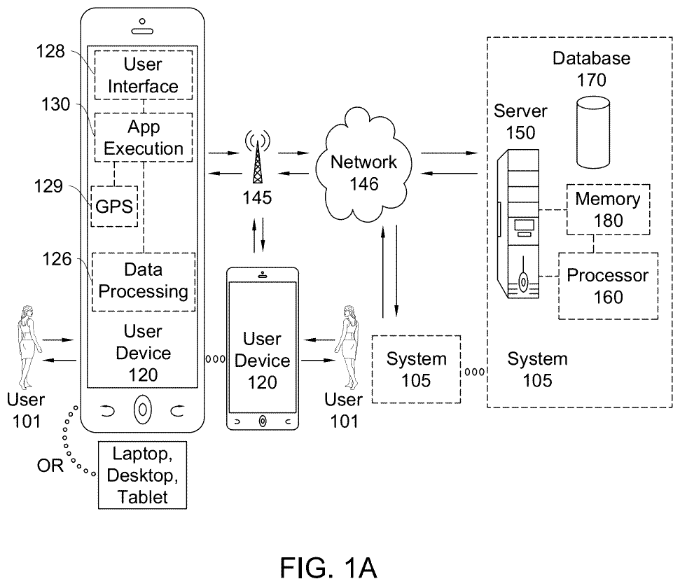

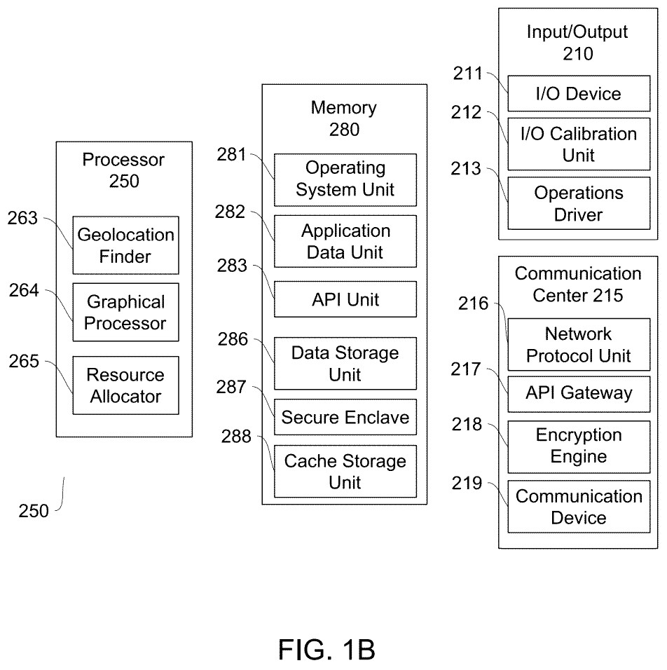

In some embodiments, any computing device, system, or apparatus described herein may be a mobile or non-mobile computing device, a mobile phone, laptop, tablet, watch, e-reader, headgear, eyewear, a front-end or back-end server, etc. Any computing device may have voice and data capabilities. In some embodiments, the term “data” may refer to “signal” or “information.” In some embodiments, the terms “signal,” “data,” and “information” may be used interchangeably. Any reference to data may also include references to the contents of the data. Any signals described herein may be electronic or electromagnetic signals. Additionally, any signals described herein may be either be transitory or non-transitory signals. Additionally, any signals described herein may be analog signals, digital signals, and/or mixed analog and digital signals. The terms “system,” “apparatus,” “server,” “box,” “agent,” “device,” “unit,” “sub-unit,” “element,” “application,” “infrastructure,” etc., may be used interchangeably in some embodiments. In some embodiments, any data or data set described herein may be structured or unstructured. In some embodiments, a method is provided for performing the various steps performed by any system described herein. In some embodiments, a non-transitory computer-readable medium comprising code is provided for causing a system to perform the various methods described herein. In some embodiments, a system may comprise one or more physical housings that include various units, such as those illustrated in FIG. 1B. In some embodiments, a chipset may be disposed in the one or more housings and may be interfaced with one or more hardware processors. The chipset may have hardware (e.g., electronic components in an electronic circuit) for supporting various connections within the system, or any other connection from the system to external systems. Any of the embodiments, elements, features, processes, compounds, portions of compounds, etc. can be combined with any other embodiments, elements, features, processes, compounds, portions of compounds, etc.

FIG. 1A describes a schematic block diagram of a network system for executing the various methods described herein. While the user device 120 is shown as a mobile phone, in other embodiments, the user device 120 may be any other mobile or non-mobile computing device, including laptops, desktops, tablets, gaming devices, wearable devices, eyewear, headgear, Internet of Things (IoT) devices, etc. The illustrated network 146, such as the Internet or an intranet, can be used to exchange data between the server 150 and the user device 120.

According to some embodiments, a user 101 and/or another computer interacts with the disclosed systems 100 for executing the methods disclosed herein. Disclosed user devices 120 may include computing device capable of sending data and communicating over the internet with one or more servers 150, other user devices 120, or other type of computing devices. The methods described herein may be executed by at least one of the user device 120 (e.g., using the app execution 130 and data processing 126 systems), the server 150 (e.g., using the processor 160), or a combination of both.

A wireless communications network 145 may be a 3G network, 4G, LTE, 5G, Wi-Fi, Bluetooth, or any other network protocol and may be a combination of any number of networks. Further, as mentioned above a wired network connection such as a conventional Ethernet connection could be used, such as with a personal computer with an Ethernet port. User devices 120 or servers 150 may include processors 430 such as digital signal processors or a microprocessors for performing the different methods described in this specification.

Although the servers 150 illustrated in the present figure are illustrated as stand-alone computing machines, the computing functionality, including servers 150, processors or processor instances 160, memory or computing data storage areas 180, and databases 170 can be provided through a cloud implementation or by a hybrid enterprise/cloud architecture. It is understood that the terms system, apparatus, device, etc. may be used interchangeably in this specification. In some embodiments, a method is provided for performing the various steps performed by any computing device, e.g. user device 120 and/or server 150, described herein. In some embodiments, a non-transitory computer-readable medium comprising code is provided for causing any user device 120, computing device, or server 150, to perform the various methods described herein. The scope of any Claims that may be a part of this application or any application stemming from the present application shall be determined by those Claims as read in light of the Claims, but the elements of the particularly illustrated embodiments shall not be imputed to the Claim language unless particularly invoked through the use of means-plus-function language under 35 U.S.C. Section 112(f).

FIG. 1B illustrates an exemplary complex computing environment, in accordance with some embodiments of the disclosure. For example, the computing environment may be included in and/or utilized by the system, the user device, and/or any other system described herein. The computing environment and/or any of its units and/or sub-units described herein may include general hardware, specifically-purposed hardware, and/or specially purposed-software.

The computing environment may include, among other units, a processor 260, a memory 280, an input/output (I/O) unit 210, and a communication center 215. As described herein, each of the processor, the memory, the I/O unit, and/or the communication unit may include and/or refer to a plurality of respective units, sub-units, and/or elements. The various units may be implemented entirely in hardware, entirely in software, or in a combination of hardware and software. Some of the units may be optional. Any software described herein may be specially purposed software for performing a particular function. In some embodiments, hardware may also be specially purposed hardware for performing some particular functions. Furthermore, each of the processor, the memory unit, the I/O unit, the communication unit, and/or the other units in FIG. 1B, may be operatively and/or otherwise communicatively coupled with each other using a chipset such as an intelligent chipset or a non-intelligent chipset. The chipset may have hardware for supporting connections in the computing environment and connections made to external systems from the computing environment. While various units of FIG. 1B are presented as separate units, some of the units may be comprised in other units. Additionally, some of the units may be optional. Additionally, one or more units may be coupled or connected (e.g., via a wired or wireless connection) to other units. For example, the processor may be connected to one or more other units in FIG. 1B.

As illustrated in FIG. 1B, a server 250 (which may be the system 105 or may be comprised in the system 105) may include, among other elements, any combination of a processor 260, a memory 280, an input/output (I/O) 210, and a communication center 215. As described in present embodiments, each of the processor 260, the memory 280, the I/O 210, and communication center 215 may include a plurality of respective units, subunits, and/or elements. Furthermore, each of the processor 260, the memory 280, the I/O 210, and the communication center 215 may be operatively or otherwise communicatively coupled with each other so as to facilitate the methods and techniques described herein. In some embodiments, at least some of the processor 260, the memory 280, the I/O 210, and the communication center 215, or any portions thereof, may be present include in one or more user devices 120. In some embodiments, methods, or portions thereof, may be performed entirely by one or more servers 150, one or more user devices 120, or may be performed by a combination of one or more servers 150 and one or more user devices 120. In some embodiments, an application server may be provided for downloading an application or software to user devices for performing the various methods described herein.

The processor 260 may control any one or more of the memory 280, the I/O 20, the communication center 215, or any other unit which may include the server 250, as well as any included subunits, elements, components, devices, or functions performed by each or a combination of the memory 280, the I/O 210, the communication center 215 or any other unit which may include the server 250. Any of the elements or sub-elements of the server 250 presented here may also be included in a similar fashion in any of the other units, subunits, and devices included in the operating system 100 of FIG. 1A. Additionally, any actions described herein as being performed by a processor 260 may be taken by the processor 260 alone, or by the processor 260 in conjunction with one or more additional processors, units, subunits, elements, components, devices, and the like. Additionally, while only one processor 260 may be shown in the figures included here, multiple processors may be present or otherwise included in the server 250 or elsewhere in the operating system of FIG. 1A. Thus, while instructions may be described as being executed by the processor 260 or the various subunits of the processor 263, 264, 265, the instructions may be executed simultaneously, serially, or otherwise by one or more multiple processors 260.

In some embodiments, a processor 260 may be implemented as one or more computer processor (CPU) chips, graphical processor (GPU) chips, or some combination of CPU chips and GPU chips, and may include a hardware device capable of executing computer instructions. The processor 260 may execute any combination of instructions, codes, computer programs, and scripts. The instructions, codes, computer programs, and scripts may be received from, stored in, or received from and stored in any combination of the memory 280, the I/O 210, the communication center 215, subunits of the previously described elements, other devices, other computing environments. In some embodiments, various portions of any of the methods described herein may be executed either in series or in parallel.

In some embodiments, the processor 260 may include, among other elements, subunits. Subunits may include any combination of a geolocation finder 263, a graphical processor 264, and a resource allocator 265. Each of these subunits of the processor 260 may be communicatively or otherwise operably coupled with each other. Any of the subunits described with respect to any units or systems may be optionally included those units or systems.

The geolocation finder 263, particularly in communication with geolocation information provided by GPS subsystems 129 of user devices 120 (see FIG. 1A) may facilitate any combination of detection, generation, modification, analysis, transmission, and presentation of location information. Location information may include any combination of global positioning system (GPS) coordinates, an internet protocol (IP) address, a media access control (MAC) address, geolocation information, an address, a port number, a zip code, a server number, a proxy name, a proxy number, device information, serial numbers, and the like. In some embodiments, the geolocation finder 263 may include any one or a combination of various sensors, specifically-purposed hardware elements for enabling the geolocation finder 263 to acquire, measure, and transform location information.

The graphical processor (GPU) 264 may facilitate any combination of generation, modification, analysis, processing, transmission, and presentation of visual content. In some embodiments, the GPU 264 may be configured to receive multiple images from a user and perform analysis on and/or modifications to the images. Further, the GPU 264 may be configured to facilitate adjustments to videos and images associated with a user. The GPU 264 may also be configured to render visual content for presentation on a user device 120 and/or to analyze visual content for metadata associated with a user or a user device. The GPU 264 may include multiple GPUs and may therefore be configured to perform and/or execute multiple processes in parallel.

The resource allocator 265 may facilitate any one or combination of the determination, monitoring, analysis, and allocation of resources throughout the server 250, the system 100, any component of the system 100, or other computing environments. For example, the resource allocator 265 may facilitate interaction between the server 250, any subunit of the server 250, and a high volume (e.g. multiple) of users or associated user devices 120. As such, computing resources of the server 250 utilized by any one or a combination of the processor 260, the memory 280, the I/O 210, the communication center 215, and any subunit of these units, such as processing power, data storage space, network bandwidth, and the like may be in high demand at various times during operation. Accordingly, the resource allocator 265 may be configured to manage the allocation of various computing resources as they are required by particular units or particular subunits of the server 250.

In some embodiments, the resource allocator 265 may include sensors and/or other specially-purposed hardware for monitoring performance of each unit and/or subunit of the server 250, as well as hardware for responding to the computing resource needs of each unit or subunit. In some embodiments, the resource allocator 265 may utilize computing resources of a second computing environment separate and distinct from the server 250 to facilitate a desired operation.

In some embodiments, factors affecting the allocation of computing resources by the resource allocator 265 may include the number of ongoing user device connections and/or other communication channel connections, a duration during which computing resources are required by one or more elements of the server 250, and/or the like. In some embodiments, computing resources may be allocated to and/or distributed amongst a plurality of second computing environments included in the server 250 based on one or more factors mentioned above. In some embodiments, the allocation of computing resources of the resource allocator 265 may include one or more resource allocators 265 flipping a switch, adjusting processing power, adjusting memory size, partitioning a memory element, transmitting data, controlling one or more input and/or output devices, modifying various communication protocols, and the like. In some embodiments, the resource allocator 265 may facilitate utilization of parallel processing techniques such as dedicating a plurality of GPUs included in the processor 260 for processing high-quality analysis and manipulation of images and/or videos.

In some embodiments, the memory 280 may be utilized for one or any combination of storing, recalling, receiving, transmitting, and/or accessing various files and/or information during operation of the server 250. For example, the memory 280 may be utilized for storing recalling, and/or updating any datasets described herein. The memory 280 may include various types of data storage media such as solid state storage media, hard disk storage media, and any other type of data storage medium which may be known to a person of ordinary skill in the art. The memory 280 may include dedicated hardware elements such as hard drives and/or servers, as well as software elements such as cloud-based storage drives. For example, the memory unit 280 may include various subunits such as an operating system unit 281, an application data unit 282, an application programming interface (API) unit 283, a data storage unit 286, a secure enclave 287, and/or a cache storage unit 288.

The memory 280 and any of its subunits described here may include any one or any combination of random access memory (RAM), read only memory (ROM), and various forms of secondary storage. RAM may be used to store volatile data and/or to store instructions that may be executed by the processor 260. For example, the data stored may be any one or a combination of a command, a current operating state of the server 250, an intended operating state of the server 250, and the like. As a further example, data stored in the memory 280 may include instructions related to various methods and/or functionalities described here. ROM may be a non-volatile memory device that may have a smaller memory capacity than the memory capacity of a secondary storage. ROM may be used to store instructions and/or data that may be read during execution of computer instructions. In some embodiments, access to both RAM and ROM may be faster than access to secondary storage. Secondary storage may include one or more disk drives and/or tape drives and may be used for non-volatile storage of data or as an over-flow data storage device if RAM is not large enough to hold all working data. Secondary storage may be used to store programs that may be loaded into RAM when such programs are selected for execution. In some embodiments, the memory 280 may include one or more databases for storing any data described here, e.g. the database 170 of FIG. 1A. Additionally or alternatively, one or more secondary databases located remotely from the server 250 may be utilized and/or accessed by the memory 280.

The operating system unit 281 may facilitate deployment, storage, access, execution, and/or utilization of an operating system utilized by the server 250 and/or any other computing environment described herein. In some embodiments, the operating system may include various hardware and/or software elements that serve as a structural framework for enabling the processor 260 to execute various operations such as the analysis of data received from user devices 120, etc. The operating system unit 281 may further store various pieces of information and/or data associated with operation of the operating system and/or the server 250 as a whole, such as a status of computing resources (e.g., processing power, memory availability, resource utilization, and/or the like), runtime information, modules to direct execution of operations described herein, user permissions, security credentials, and the like.

The application data unit 282 may facilitate deployment, storage, access, execution, and/or utilization of an application utilized by the server 250 or any other computing environment described herein (e.g., a user device 120). For example, users may be required to download, access, and/or otherwise utilize a software application on a user device 120 such as a smartphone or other internet-enabled device in order for various operations described herein to be performed. As such, the application data unit 282 may store any information and/or data associated with the application which may allow the application and/or user device 220 to perform methods described herein. As such, information included in the application data unit 282 may enable a user to execute various operations described here. The application data unit 282 may further store various pieces of information and/or data associated with operation of the application and/or the server 250 as a whole, such as a status of computing resources (e.g., processing power, memory availability, resource utilization, and/or the like), runtime information, modules to direct execution of operations described herein, user permissions, security credentials, and the like.

The application programming interface (API) unit 283 may facilitate deployment, storage, access, execution, and/or utilization of information associated with APIs of the server 250 and/or any other computing environment described herein (e.g., a user device). For example, server 250 may include one or more APIs for enabling various devices, applications, and/or computing environments to communicate with the server 250, multiple other servers, databases, or other user devices. Accordingly, the API unit 283 may include API databases containing information that may be accessed and/or utilized by applications and/or operating systems of other devices and/or computing environments associated with the methods described herein. An API may direct communications between the background component of the user device 120 and the server 250. In some embodiments, each API database may be associated with a customized physical circuit included in the memory unit 280 and/or the API unit 283. Additionally, each API database may be public and/or private, and so authentication credentials may be required to access information in an API database.

The data storage unit 286 may facilitate one or more of deployment, storage, access, analysis, and utilization of data content by the server 250 and any other computing environment described herein (e.g., a user device). Data content may be text, numbers, images, videos, audio files, and any other form of media. For example, the data storage unit 286 may store one or more images which may be uploaded from a user device. Further, the data storage unit 286 may store one or more images which have been manipulated by any unit or subunit of a server 150 or user device. In some embodiments, the data storage unit 286 may communicate with the GPUs 264 to facilitate any of the processes described here.

The secure enclave 287 may facilitate secure storage of data. In some embodiments, the secure enclave 287 may include a partitioned portion of storage media included in the memory unit 280 that is protected by various security measures. For example, the secure enclave 287 may be hardware secured. In other embodiments, the secure enclave 287 may include one or more firewalls, encryption mechanisms, and/or other security-based protocols. Authentication credentials of a user may be required prior to providing the user access to data stored within the secure enclave 287. In some embodiments, the secure enclave 287 may store sensitive user information such as medical history, credit card data, and/or data associated with the progression of skin damage from ultraviolet radiation.

The cache storage unit 288 may facilitate short-term deployment, storage, access, analysis, and/or utilization of data. In some embodiments, the cache storage unit 288 may serve as a short-term storage location for data so that the data stored in the cache storage unit 288 may be accessed quickly. In some embodiments, the cache storage unit 288 may include RAM and/or other storage media types that enable quick recall of stored data. The cache storage unit 288 may include a partitioned portion of storage media included in the memory 280. In some embodiments, the cache storage unit 288 may store any data described herein.

In some embodiments, the memory 280 or the processor 260 may include one or more data sensors for sensing parameters associated with any data described herein.

The I/O unit 210 may include hardware and/or software elements for enabling the server 250 to receive, transmit, and/or present information. For example, elements of the I/O unit 250 may be used to receive user input from a user via a user device 220, and the like. In this manner, the I/O unit 210 may enable the server 250 to interface with a human user in a manner such that the user may use the methods described here. As described, the I/O unit 210 may include subunits such as any one or a combination of an I/O device 211, an I/O calibration unit 212, and/or operations driver 213.

The I/O device 210 may facilitate any one or any combination of the receipt, transmission, processing, presentation, display, input, and output of information as a result of executed processes described here. In some embodiments, the I/O device 210 may include a plurality of I/O devices. In some embodiments, the I/O device 210 may include one or more elements of any one or a combination of a user device 120, a server 250, and/or a similar device(s).

The I/O device 211 may include a variety of elements that enable a user to interface with the server 250. For example, the I/O device 211 may include a keyboard, a touchscreen, a button, a sensor, a biometric scanner, a laser, a microphone, a camera, an internet-enabled device, and/or another element for receiving and/or collecting input from a user. Additionally and/or alternatively, the I/O device 211 may include a display, a screen, a sensor, a vibration mechanism, a light emitting diode (LED), a speaker, a radio frequency identification (RFID) scanner, and/or another element for presenting and/or otherwise outputting data to a user. In some embodiments, the I/O device 211 may communicate with one or more elements of the processor 260 and/or the memory unit 280 to execute operations described herein. For example, the I/O device 211 may include a display, which may utilize the GPU 264 to present media content stored in the data storage unit 286 to a user of a user device 120.

The I/O calibration unit 212 may facilitate the calibration of the I/O device 211. For example, the I/O calibration unit 212 may detect and/or determine one or more settings of the I/O device 211, and then adjust and/or modify settings so that the I/O device 211 may operate more efficiently. In some embodiments, the I/O calibration unit 212 may utilize an operations driver 213 (or multiple operations drivers) to calibrate the I/O device 211. The operations driver 213 may alternatively be installed on a user device 120 so that the user device 120 may recognize and/or integrate with the I/O device 211, thereby enabling media content to be displayed, received, generated, and the like. In some embodiments, the I/O device 211 may be calibrated by the I/O calibration unit 212 by based on information included in the operations driver 213.

The communication center 215 may facilitate establishment, maintenance, monitoring, and/or termination of communications between the server 250 and other devices such as user devices 120, other computing environments, third party server systems, and the like. The communication center 215 may further enable communication between various elements (e.g., units and/or subunits) of the server 250 as needed to perform the methods described herein. In some embodiments, the communication center 215 may include a network protocol unit 216, an API gateway 217, an encryption engine 218, and/or a communication device 219. The communication center 215 may include hardware and/or software elements.

The network protocol unit 216 may facilitate establishment, maintenance, and/or termination of a communication connection between the server 250 and another device (e.g. user device 120) by way of a network. For example, the network protocol unit 216 may detect and/or define a communication protocol required by a particular network and/or network type. Communication protocols utilized by the network protocol unit 216 may include Wi-Fi protocols, Li-Fi protocols, cellular data network protocols, Bluetooth® protocols, WiMAX protocols, Ethernet protocols, powerline communication (PLC) protocols, and the like. In some embodiments, facilitation of communication between the server 250 and any other device, as well as any element internal to the server 250, may include transforming and/or translating data from being compatible with a first communication protocol to being compatible with a second communication protocol. In some embodiments, the network protocol unit 216 may determine and/or monitor an amount of data traffic to consequently determine which particular network protocol is to be used for establishing a connection with a user device, transmitting data, and/or performing other operations described herein.

The API gateway 217 may facilitate the enablement of other devices and/or computing environments to access the API unit 283 of the memory 280 of the server 250. For example, a user device 120 may access the API unit 283 via the API gateway 217. In some embodiments, the API gateway 217 may be required to validate user credentials (e.g. login ID 225, password 226 of FIG. 1B) associated with a user of a user device 120 prior to providing access to the API unit 283 to the user. The API gateway 217 may include instructions for enabling the server 250 to communicate with another device.

The encryption engine 218 may facilitate any one or any combination of translation, encryption, encoding, decryption, and decoding of information received, transmitted, and/or stored by the server 250. For example, the encryption engine 218 may encrypt data associated with a user's medical history, credit card information, analysis of skin damage from ultraviolet radiation, etc. Using the encryption engine, each transmission of data may be encrypted, encoded, and/or translated for security reasons, and any received data may be encrypted, encoded, and/or translated prior to its processing and/or storage. In some embodiments, the encryption engine 218 may generate any one or combination of an encryption key, an encoding key, a translation key, and the like, which may be transmitted along with any data content.

The communication device 219 may include a variety of hardware and/or software specifically purposed to enable communication between the server 250 and another device (e.g. user device 120), as well as communication between elements of the server 250. In some embodiments, the communication device 219 may include one or more radio transceivers, chips, analog front end (AFE) units, antennas, processors, memory, other logic, and/or other components to implement communication protocols (wired or wireless) and related functionality for facilitating communication between the server 250 and any other device. Additionally and/or alternatively, the communication device 219 may include a modem, a modem bank, an Ethernet device such as a router or switch, a universal serial bus (USB) interface device, a serial interface, a token ring device, a fiber distributed data interface (FDDI) device, a wireless local area network (WLAN) device and/or device component, a radio transceiver device such as code division multiple access (CDMA) device, a global system for mobile communications (GSM) radio transceiver device, a universal mobile telecommunications system (UMTS) radio transceiver device, a long term evolution (LTE) radio transceiver device, a worldwide interoperability for microwave access (WiMAX) device, and/or another device used for communication purposes.

In some embodiments, implementation of any unit of any system described herein is contemplated in discrete components or fully integrated circuits in silicon, gallium arsenide, or other electronic materials families, as well as in other technology-based forms and embodiments. It should be understood that various embodiments of the disclosure can employ or be embodied in hardware, software, microcoded firmware, or any combination thereof. When an embodiment is embodied, at least in part, in software, the software may be stored in a non-volatile, machine-readable medium.

The process in which a user can use computing technology to return their unused, clean, nice, good, whole boxes after a package has been delivered. The item provided or delivered or given, sell or return, or get incentivized by providing (e.g., discount, coupon, money, payment, non-payment, free items, free gifts, etc.) to (e.g., return, give, or donate good condition boxes to businesses, retail, or e-commerce, etc.) In some embodiments, related to Good condition (or gently used or cared for or no damage or light damage or light or no visual damage or reusable condition) box return or donation, or selling, or donating, or crushing, or giving, or recycling. In some embodiments, a computing process of picking up folded boxes from residences or businesses after a package has been delivered, rather than crushing the box or throwing the box away, by using computing systems, alerts, technology, data, etc. In some embodiments, taking the box that is folded or in box form and selling it back to the business that dropped off the original item in the box, so they don't have to buy more boxes or spend time or effort folding boxes when the returned or reused boxes or packages are in good condition shape or good shape or a shape that can be reused or bought or donated. In some embodiments, AI or a human or scanner can be used to analyze items, boxes, and products to (e.g., obtain data, insert data into an app or computing system, etc.). In some embodiments, It can use that data to notify 3rd parties or connected computing data users.

In some embodiments, a computing process is disclosed for facilitating the purchase of a lottery ticket through a mobile device. In some embodiments, The process involves receiving a request from a user via a mobile application to buy a lottery ticket. Subsequently, a set of digital lottery numbers is generated and provided to the user's mobile device in response to the purchase request. In some embodiments, These digital lottery numbers are securely associated with the user's account information, ensuring the integrity and confidentiality of the lottery ticket data. In some embodiments, The completion of the lottery ticket purchase transaction is confirmed, finalizing the user's participation in the lottery. In some embodiments, the computing process incorporates a random number generation computing operation to generate the digital lottery numbers. In some embodiments, This computing operation ensures unpredictability and fairness in assigning lottery numbers, enhancing the integrity of the lottery ticket purchasing process. In some embodiments, the computing process may include presenting a graphical representation of the purchased lottery ticket on the user's mobile device. In some embodiments, This representation may include the generated digital numbers and relevant lottery details. In some embodiments, the user is afforded the option to customize or select specific numbers for their lottery ticket through the mobile application before finalizing the purchase, providing a personalized and interactive experience. In some embodiments, the user's mobile device is authenticated through secure methods such as biometric authentication, PIN codes, or two-factor authentication to ensure the security of the lottery ticket purchase transaction, safeguard user information, and prevent unauthorized access. In some embodiments, the computing process integrates a digital wallet or payment gateway functionality into the mobile application. In some embodiments, This allows for the facilitation of secure payment for the purchased lottery ticket, and the completion of the payment transaction is confirmed before finalizing the issuance of the digital lottery numbers. In some embodiments, the digital lottery numbers are securely stored in a database associated with the lottery service provider. In some embodiments, This ensures the integrity and confidentiality of the lottery ticket information, protecting user data and lottery ticket details from unauthorized access. In some embodiments, a digital confirmation receipt is sent to the user's mobile device, providing details of the purchased lottery ticket, including date, time, and transaction confirmation information. In some embodiments, The user is further provided with the capability to access the digital confirmation receipt through the mobile application at any time, enhancing transparency and user engagement. In some embodiments, the purchased lottery ticket is automatically entered into relevant lottery drawings or events based on the selected numbers and the schedule of the lottery service provider. In some embodiments, this streamlines the process for users and ensures their participation in the appropriate lottery events. In some embodiments, a computing system is configured to perform the disclosed method, providing a technological framework for implementing the innovative process of buying a lottery ticket through a mobile device and receiving digital lottery numbers. In some embodiments, a non-transitory computer-readable storage medium stores instructions that, when executed by a processor, cause the processor to perform the method, offering a tangible and practical embodiment of the described computing process for buying lottery tickets through a mobile device.

In some embodiments, a computing process in which a customer, human, robot, or person may watch the screen on the computing device and watch an ad on their personal device or someone else's personal device when receiving an order instead of tipping. In some embodiments, a computing process is provided for facilitating order placement. In some embodiments, The process involves receiving an order request from a customer on a computing device. In some embodiments, the availability of an advertisement viewing option associated with the order request is determined. In certain instances, this determination may consider factors such as the nature of the order, the customer's preferences, and the advertisements currently available. In some embodiments, the computing process may include presenting, on the computing device, an option for the customer to watch an advertisement on either their personal device or another person's personal device. In some embodiments, This option is presented as an alternative or addition to traditional payment or tipping methods. Upon the customer's selection of the advertisement viewing option, the computing process further comprises displaying the chosen advertisement on the specified device. In some embodiments, the advertisements may be sent to their personal device to watch or review or complete requirements; it may be shown by the other party, it may be shown on a projector, it may be shown on a screen, it may be heard, it may be felt, it may show up as a projection, it may require the other party or parties to interact with the live person or a live advertisement, or a live ‘to-do list’ or a ‘live requirement such as clicking, tapping, answering questions, etc.’)

In some embodiments, an incentive system is integrated into the advertisement viewing option. In some embodiments, the customer, by choosing to watch an advertisement in connection with their order, becomes eligible to receive a discount, reward, or other benefits. In some embodiments, This incentivizes the customer to engage with the advertisement content during the order placement process. In some embodiments, the computing process involves tracking the duration and completion of the advertisement viewed by the customer. In some embodiments, This information is then utilized to determine an appropriate credit or compensation for the customer. Subsequently, the credited amount is applied towards the cost of the placed order, providing a tangible benefit to the customer based on their engagement with the advertisement. In some embodiments, the advertisement viewing option is seamlessly presented through a graphical user interface on the computing device. In some embodiments, this interface allows the customer to initiate and complete the advertisement viewing process without disruption to the overall order placement experience. In some embodiments, the computing process may include obtaining explicit consent from the customer to share information related to their order and advertisement viewing preferences with advertisers or third-party entities. In some embodiments, This shared information is subsequently utilized to deliver targeted and personalized advertisements to the customer during the order placement process, enhancing the overall advertising experience. In some embodiments, the personal device on which the advertisement is viewed encompasses a wide range of portable electronic devices, including but not limited to smartphones, tablets, smartwatches, or any other device capable of displaying multimedia content. In some embodiments, a computing system is configured to perform the method outlined in any of the preceding Claims, providing a technological framework for implementing the innovative order placement and advertisement viewing process. In some embodiments, a non-transitory computer-readable storage medium stores instructions that, when executed by a processor, cause the processor to perform the method outlined in any of the preceding Claims, offering a tangible and practical embodiment of the described computing process. In some embodiments, a customer, human, robot, or person may stand there and watch the screen on the computing device and watch the ad. Work in person for a product or service instead of paying/tipping. In some embodiments, it may work from the personal device for a product or service instead of paying/tipping. In some embodiments, Use credit cards to apply coupons for retailers, and when or if the user uses a 3rd party delivery or pickup or service to obtain that item, that item can still be used with coupon codes or with credit card discounts that are added to the credit card.

In some embodiments, users or customers may receive Coupons in the mail or email and apply them to food delivery or any delivery order. In some embodiments, Paying can mean a portion of an order, a tip for an order, or taxes for an order. In some embodiments, consumers or customers or users can do these things ‘such as a requirement from an advertiser or the company’ to get a discount. In some embodiments, video advertisements or any interactive advertisements can not be changed or fast forward. In some embodiments, The user may need to provide their personal information or a verified list of their information in order to get a discount or money or payment or percent off of money or in exchange for payment. In some embodiments, If the ad is too long or there is a line option of automatic transfer to a cell phone to finish watching the clip, one can't exit until the clip is over. In some embodiments, Variations in the clips are based on timing, etc.; for example, a 30-second ad gives a 10% tip. In some embodiments, Another variation could be Two 30-second ads giving a 20% tip. In some embodiments, this advertisement in exchange for payment may Only work after someone makes a purchase with credit, debit, or crypto payment. In some embodiments, an Ad is shown to a person based on their gender, the location, the restaurant that the person is in, the city, the statistics of that person, etc. In some embodiments, Every partner automatically has this feature integrated into their “tipping page,” which, rather than the “regular tipping page,” there is a clear option to “tip or complete advertisement requirements.”. In some embodiments, Audience/user understands what “tip or complete advertisement requirements is” because it explains to the “potential tipper” that either you can tip from your own form of payment or you can watch an “ad” or a “clip” or a “promotion through video, message, hologram, email message, inserting your verified cell phone number, address, name, age, personal information, or signing up for something” in order to avoid tip payment from your card, and allow the “advertiser” to pay the tip directly to the “delivery person, restaurant, service provider, etc.” rather than it coming from the “users' card.” In some embodiments, The type of “advertisement” is based on the assumed or given information on “name, age, location, service being provided, time of the day, time of the year, whether its a holiday, whether they are a frequent customer, etc. In some embodiments, If someone refuses to give basic information for the ‘tip or complete advertisement requirements,’ then the advertisement will do its best to provide an ad based on other information such as ‘type of establishment, type of transaction, etc.” In some embodiments, This can be in a restaurant, an internet transaction such as ‘door dash,’ a massage parlor, a haircutting provider, a lash service technician, a facial, purchasing groceries, purchasing items from the store, buying makeup, etc.

In some embodiments, Another feature is that lottery tickets can be bought through “tip or complete advertisement requirements,” so the advertiser is paying for the lottery ticket that can be added to the checkout screen. In some embodiments, the advertiser that pays for the lottery ticket is signing away its rights to the ticket if it is a winner in order to show the advertisement to the customer in exchange for the lottery ticket. In some embodiments, service providers, users, persons, etc., have options to purchase lottery tickets through features on any delivery, picking, service, and any other service provider such as ‘facials, massages, hair cutting, beard shaving, extractions, acne treatments, etc. In some embodiments, lottery tickets can be delivered through discreet and confidential packaging from the lottery ticket providers to the customers through service or delivery. In some embodiments, gift cards can be purchased through “tip or complete advertisement requirements,” so the advertiser is paying for the gift cards that can be added to the checkout screen. Nonrefundable once the advertiser shows the ‘clip or advertisement to the customer in exchange for the gift card.’ In some embodiments, gift cards can be delivered through discreet and confidential packaging from the gift card providers to the customers through service or delivery. In some instances, if you watch the video or advertisement, it can be exchanged for paying the “tax payment’ on the order rather than providing payment for the tip. In some embodiments In some instances, both the tax payment and the tip can be provided by advertisers by watching, interacting with, or providing verified information for advertisers to collect in exchange for tax and or tip on any service option, delivery, purchase, or agreement, or transfer of funds, goods, services, etc. In some embodiments, some instances, baby formula, baby items, or children's items such as books or educational content can sometimes be paid, partially paid, tax paid, or tip paid for by ‘tip or complete advertisement requirements’ in exchange for watching their advertisement, providing detailed or verified information to the advertiser, watching video ads on their phone, or interacting with advertisers in order for them to sell you their products, goods, services, either now or at a later date. In some embodiments, the process which an application store or marketplace, whether on a phone, integrated into a phone, or downloaded into a phone or computing device, personal device, or computer, has an ‘application store, or a store or a marketplace where users can create and add their own applications, and the store gets 0% fees from any purchases made between the user and the store. In some embodiments, The money only goes to the person who is selling the product. In some embodiments, the process of making cauliflower wings is paired with a ranch, blue cheese, or any sauce. In some embodiments, Cauliflower flower wings may be created or combined with sauces or the sauces used outside the wings. In some embodiments, A software system that bakes, fries, makes, and cooks cauliflower wings, which may include shaking the wings in a bowl to combine the outer layer or inner layer coating or soaking a sauce or liquid substance or power substance, and pouring into a cup, bowl, plate, bag, etc. In some embodiments, the process of making a cauliflower wing patty for a burger or a burger item.

In some embodiments, Software for computing systems where facial recognition devices for food delivery or gig apps on phones where the person that signs up is the person that needs to accept orders or make gigs such as driving, etc. In some embodiments, a software system is disclosed for gig or food delivery applications on computing devices. In some embodiment, the system may include a facial recognition module that is configured to capture and authenticate the facial features of an individual during the signup process. In some embodiment, the authenticated facial features are then associated with a user profile, effectively linking the individual's identity to the corresponding gig or food delivery application account. In some embodiment, the software system further comprises a user interface that allows the individual to accept orders or engage in various gigs, such as driving, delivering, and picking up items, exclusively when the facial recognition authentication matches the registered user during the active session. In some embodiments, the facial recognition module employs advanced facial recognition computing operations to ensure a high degree of accuracy in identifying and authenticating the individual both during the signup process and throughout the active session. In some embodiment, this utilization of cutting-edge computing operations enhances the reliability and precision of facial recognition authentication. In some embodiments, the software system may include a real-time facial recognition verification process during each session, serving to confirm the identity of the individual actively engaging in gigs or food delivery orders. In some embodiment, this real-time verification process adds an additional layer of security and authenticity to the user's identity throughout the active engagement. In some embodiments, the facial recognition module is seamlessly integrated into a mobile application, ensuring portability and convenience for users participating in gig or food delivery activities. In some embodiment, this integration facilitates a user-friendly experience and enables individuals to engage in activities on the go. In some embodiments, the software system incorporates an authentication log that records facial recognition verification attempts and results. In some embodiment, this log serves auditing, security, and compliance purposes, providing a comprehensive record of authentication activities for review and analysis. In some embodiments, the user profile associated with the facial features may include additional verification steps, such as document verification or biometric authentication. In some embodiment, these additional steps enhance the overall security and authenticity of the user's identity, ensuring a multi-layered approach to identity verification. In some embodiments, the gig or food delivery application, integrated into the software system, may include features such as order acceptance, navigation, and communication tools. In some embodiment, these features are accessible only upon successful facial recognition authentication, adding an extra layer of security to the application's functionalities. In some embodiments, the software system comprises an alert system that notifies both the user and the platform administrator in case of a facial recognition mismatch or suspicious activity during gig or food delivery engagements. In some embodiment, this proactive alert mechanism enhances security measures and allows for timely intervention in case of potential unauthorized activities. In some embodiments, the facial recognition module is designed to adapt to varying environmental conditions, ensuring reliable authentication in different lighting and background scenarios. In some embodiment, this adaptability enhances the robustness of the facial recognition system in diverse settings. In some embodiments, the software system incorporates a privacy control feature, allowing the user to manage and control the storage and usage of facial recognition data in compliance with privacy regulations. In some embodiment, this feature empowers users to maintain control over their personal information and aligns with privacy best practices. In some embodiments, a computing system is configured to execute the software system, providing a technological framework for implementing the facial recognition-based identity verification for gig or food delivery applications. In some embodiments, a non-transitory computer-readable storage medium stores instructions that, when executed by a processor, cause the processor to perform the steps of the software system, offering a tangible embodiment of the described facial recognition authentication process for gig or food delivery applications.

In some embodiments, a software system is presented to facilitate curbside pickup or delivery pickup for physical items efficiently. In some embodiment, the system may include a user interface enabling users to conveniently pre-order physical items for either curbside pickup or delivery. To streamline the process, the system incorporates car recognition technology, configured to identify and authenticate the approaching vehicle using visual data or other sensors. In some embodiment, a additionally, GPS functionality is integrated to determine the location and proximity of the vehicle in relation to the designated pickup point. In some embodiment, a notification system is employed to alert store employees or service providers of the approaching vehicle, prompting them to prepare and promptly deliver the pre-ordered items. In some embodiments, the user interface provides an enhanced experience by allowing users to select a specific pickup time. In some embodiment, this feature ensures timely preparation and availability of the pre-ordered items upon the vehicle's arrival, optimizing convenience for both users and service providers. In some embodiments, the car recognition technology goes beyond mere identification, employing advanced image recognition computing operations or other visual identification techniques to uniquely identify and associate the approaching vehicle with the specific pre-ordered items, enhancing accuracy and efficiency. In some embodiments, the software system may include a communication module that facilitates real-time communication between the user and store employees or service providers. In some embodiment, this functionality allows for updates, clarifications, or special instructions related to curbside pickup or delivery pickup, promoting a seamless and responsive interaction. In some embodiments, the GPS functionality is configured not only to determine the location of the vehicle but also to provide navigation instructions to the user. In some embodiment, these instructions direct the user to the designated pickup point with optimal routing, ensuring a smooth and efficient process. In some embodiments, the notification system is comprehensive, sending alerts to store employees or service providers.

In some embodiment, these alerts include details about the approaching vehicle and the pre-ordered items, enabling efficient preparation and delivery and minimizing any potential delays. In some embodiments, car recognition technology employs machine learning models. In some embodiment, this allows the system to adapt and improve the accuracy of vehicle recognition over time, enhancing the system's ability to uniquely identify approaching vehicles with increasing precision. In some embodiments, a user authentication mechanism is integrated into the software system. In some embodiment, this mechanism ensures that only authorized users are able to initiate pre-orders and access the curbside pickup or delivery pickup services, enhancing security and preventing unauthorized access. In some embodiments, the user interface provides users with the option to customize their curbside pickup or delivery pickup preferences. In some embodiment, this may include but is not limited to, specifying delivery to a specific car door or trunk, allowing for personalized and flexible user experiences. In some embodiments, the notification system is configured to send notifications to the user. In some embodiment, these notifications confirm that the pre-ordered items are ready for pickup and provide any additional instructions or information, offering transparency and timely updates to the user. In some embodiments, a computing system is configured to execute the software system, providing a technological infrastructure for implementing the innovative curbside pickup or delivery pickup process for physical items. In some embodiments, a non-transitory computer-readable storage medium stores instructions that, when executed by a processor, cause the processor to perform the steps of the software system. In some embodiment, this tangible embodiment offers practical implementation of the described curbside pickup or delivery pickup process for physical items. Software for vehicle or transportation devices that you can pre-order curbside pick up for physical items, such as Pepto-Bismol or eyeliner, so your time up pulling into the store right now if you go on there. Car recognition for curbside pickup or delivery pickup for food delivery or recognizing vehicles through drive-through for pickup or regular orders.

In some embodiments, a method is provided for creating a drive-through order or any order using a mobile or personal device. In some embodiment, the method involves receiving an order request through a mobile application on the user's device. Car recognition software is utilized to identify and authenticate the user's vehicle based on visual data or other sensors. Subsequently, the drive-through order is automatically processed and prepared without necessitating manual confirmation or alteration on the user's personal device. In some embodiment, the prepared order is delivered to the identified and authenticated vehicle upon its arrival at the drive-through location. In some embodiments, the car recognition software employs advanced image recognition computing operations or other visual identification techniques to uniquely identify the user's vehicle and associate it with specific order details. In some embodiment, this enhances the accuracy and reliability of the vehicle identification process within the drive-through system. In some embodiments, the method may include providing the user with real-time updates and notifications regarding the status and readiness of the drive-through order. In some embodiment, this feature ensures transparency and user engagement, keeping the user informed throughout the order preparation process. In some embodiments, the drive-through order is processed and prepared based on the user's historical preferences, order history, or predefined settings stored in the mobile application. In some embodiment, this personalized approach enhances the user experience and streamlines the order fulfillment process. In some embodiments, the car recognition software adapts and improves over time by utilizing machine learning models. In some embodiment, this adaptive learning capability enhances the system's ability to accurately identify and associate vehicles with drive-through orders, optimizing performance and efficiency. In some embodiments, the user's mobile device is equipped with location-sharing functionality. In some embodiment, this functionality provides real-time information to the drive-through system, optimizing order preparation based on the vehicle's proximity to the drive-through location. In some embodiments, a system is provided for implementing the described method. In some embodiment, the system may include a mobile application with order creation capabilities, car recognition software utilizing visual data or other sensors for identifying and authenticating vehicles, and a drive-through processing system configured to automatically prepare and deliver orders to recognized and authenticated vehicles. In some embodiments, a non-transitory computer-readable storage medium stores instructions that, when executed by a processor, cause the processor to perform the steps of the described drive-through order creation and processing method.

In some embodiment, this tangible embodiment facilitates the practical implementation of the innovative drive-through system. In some embodiments, a computer program product is disclosed, comprising computer-readable instructions stored on a non-transitory medium. In some embodiment, the execution of these instructions by a processor implements the steps of the described method, facilitating the creation and processing of drive-through orders using car recognition technology. In some embodiments, a drive-through order processing system is provided, including means for receiving order requests through a mobile application, car recognition means utilizing visual data or other sensors to identify and authenticate vehicles, means for automatically processing and preparing drive-through orders without requiring manual confirmation or alteration on user devices, and means for delivering the prepared orders to identified and authenticated vehicles upon their arrival at the drive-through location. In some embodiments, the drive-through order processing system further may include means for providing real-time updates and notifications to users regarding the status and readiness of their drive-through orders, enhancing communication and user satisfaction. In some embodiments, the car recognition means within the system incorporates advanced image recognition computing operations or other visual identification techniques to uniquely identify and associate vehicles with specific order details, ensuring precision in the order fulfillment process. In some embodiments, car recognition adapts and improves over time by utilizing machine learning models, enhancing its accuracy in identifying and associating vehicles with drive-through orders. In some embodiment, this adaptive learning capability optimizes the system's performance and reliability. In some embodiments, the means for automatically processing and preparing drive-through orders utilize user preferences, order history, or predefined settings stored in the mobile application. In some embodiments, This personalized approach streamlines the order fulfillment process and enhances the user experience. In some embodiments, the drive-through order processing system is integrated with location-sharing functionality in user mobile devices to optimize order preparation based on the proximity of vehicles to the drive-through location. In some embodiment, this integration ensures efficient and timely order fulfillment, minimizing wait times for users. Pay to update their menu on our software. Menus show up on car or deluxe for ordering—display screen in the wheel of a vehicle for ordering, pickup, or takeout. Drive through software to earphones or business local location software creating orders. Or create an order in the drive-through from your phone. Drive through the device process. In some embodiments, when a user pulls up to a drive-thru menu, the user can establish a near or long-range communication with the restaurant either using the user's mobile device (e.g., phone) or using the communication device built into the user's vehicle. For example, the user may scan a QR code or other readable code placed on the menu or in the vicinity of the restaurant using the user's mobile device. Alternatively, the user's vehicle or face may be recognized using one or more camera or scanning systems. As an example, scanning the code may pull up an application such that the user can establish a voice or video communication with the restaurant. Alternatively, when the user or the user's vehicle is recognized, a voice or video call is established between a computing system of the restaurant and the user's mobile device or vehicle. The call may be established via a computing system/user located within the restaurant or remotely from the restaurant. Accordingly, the user may be able to order a food or drink without rolling down their window and without a speaker system being present near the menu located in the drive-through lane. By establishing a voice or video call using the user's mobile device or vehicle, clear communication can be established with the restaurant without any distractions (wind, rain, noise, etc.).

In some embodiments, a computing system is disclosed for facilitating food transactions, comprising a user interface that allows a user to post a specified budget for a meal or food item. In some embodiment, the system may include a bidding module that enables restaurants to submit bids in response to the user's posted budget, with bids containing details on the proposed meal or food item, such as menu items, quantity, and additional offerings. In some embodiment, a matching computing operation is employed to determine the winning bid based on the user's preferences and the submitted bids, with a transaction processing system executing the transaction between the user and the selected restaurant. In some embodiments, the user interface may include options for specifying preferences, dietary restrictions, or cuisine preferences to refine the bidding process and enhance user satisfaction. In some embodiment, this feature provides users with a personalized and tailored experience when engaging in the food transaction process. In some embodiments, the computing system further comprises a recommendation engine providing suggestions to the user based on historical preferences, order history, or user profile information. In some embodiment, this assists the user in crafting a suitable budget and enhances the overall user experience by offering relevant and personalized recommendations. In some embodiments, the bidding module may include a real-time updating feature, allowing restaurants to adjust and modify their bids as needed to compete for the user's business. In some embodiment, this dynamic bidding environment ensures competitiveness among restaurants, leading to improved offerings and value for the user. In some embodiments, the user interface provides options for the user to choose between pickup orders, dine-in, or delivery, and the bidding module adjusts bids accordingly based on the chosen mode of food service. In some embodiment, this flexibility caters to diverse user preferences and allows for a seamless transition between different modes of service. In some embodiments, the computing system further comprises a user rating and feedback system, allowing users to rate and provide feedback on the quality of the meals or food items received, as well as the overall experience with the chosen restaurant. In some embodiment, this fosters transparency and helps users make informed decisions based on the experiences of others. In some embodiments, the bidding module incorporates machine learning computing operations to analyze user preferences and bidding patterns, optimizing the matching computing operation over time to improve bid relevance and user satisfaction. In some embodiment, this adaptive learning capability enhances the system's efficiency and accuracy in catering to user preferences. In some embodiments, the transaction processing system may include secure payment functionality, allowing users to make payments for the selected meal or food item directly through the system. In some embodiment, this feature ensures a secure and streamlined payment process, enhancing the overall user experience.

In some embodiments, the bidding module may include an alert system notifying users of new bids, promotions, or special offers from restaurants that match or exceed the specified budget. In some embodiment, this real-time notification feature keeps users informed and engaged, encouraging participation in the bidding process. In some embodiments, a method is disclosed for facilitating food transactions in a computing system involving receiving a specified budget for a meal or food item from a user through a user interface. In some embodiment, the method enables restaurants to submit bids in response to the user's posted budget, with the bids containing details on the proposed meal or food item. In some embodiment, a matching computing operation determines the winning bid based on the user's preferences and the submitted bids, with the transaction executed between the user and the selected restaurant. In some embodiments, the method may include refining the bidding process by allowing users to specify preferences, dietary restrictions, or cuisine preferences through the user interface. In some embodiment, this customization enhances the user's ability to receive bids that align with their preferences. In some embodiments, the method may include providing suggestions to the user through a recommendation engine based on historical preferences, order history, or user profile information to assist in crafting a suitable budget. In some embodiment, this guidance improves the user's decision-making process during the budgeting phase. In some embodiments, the method may include adjusting and modifying bids in real-time using a bidding module to allow restaurants to compete for the user's business. In some embodiment, this real-time adjustment ensures a dynamic and competitive bidding environment. In some embodiments, the method may include allowing users to choose between pickup orders, dine-in, or delivery through the user interface and adjusting bids accordingly based on the chosen mode of food service. In some embodiment, this flexibility accommodates diverse user preferences and provides a tailored experience. In some embodiments, the method may include analyzing user preferences and bidding patterns using machine learning computing operations within the bidding module to optimize the matching computing operation over time. In some embodiment, this adaptive learning capability enhances the system's efficiency and accuracy in catering to user preferences. In some embodiments, the method may include notifying users of new bids, promotions, or special offers from restaurants that match or exceed the specified budget through an alert system. In some embodiment, this real-time notification feature keeps users engaged and informed about available options. In some embodiments, a computer-readable storage medium is disclosed storing instructions that, when executed by a processor, cause the processor to perform the steps of the method for facilitating food transactions.

In some embodiment, this tangible embodiment provides a practical and executable implementation of the described method. Overall, the disclosed computing system and method introduce an innovative approach to food transactions, promoting user engagement, personalization, and competitiveness among restaurants while optimizing the user experience. Food out to eat offer, food restaurant offer. User or consumer or person or robot or ai Submit the amount of money you want to spend on dinner, lunch, breakfast, brunch, and restaurants send you an automatic offer on what you can get, can also get it delivered, etc. In some embodiment, the restaurants or good places may pay to show up first on the list of items available; there may be no subscription fees for the consumer, but the restaurants may pay a monthly price or an advertisement price to show up first. In some embodiment, the restaurants have a set volume or set price of each day of the week a specific meal prep item that the consumer can get for a set price, such as 10, 15, 20, delivered with taxes and fees, and all prices included in that 10, 15, 20 meal package. I have 20$. Show me what I can get for 20 makeup packages x. I have 15 dollars per day to spend on food; what can I get? Show me restaurant packages I can get for 15 for a meal. Show me a food budget for the month. Calculating what you can get for the month to hire people to bring you your food or have food delivered. Combining delivery and food scheduling. Combining restaurants and each item into one delivery or pickup order that appears at a specific location, whether delivery or pick up location. In some embodiments, the bidding system may pair with 3rd parties for delivery or bids or offers for delivery drivers, food delivery, food pickup, etc.

In some embodiments, the platform or software or app may sell the boxes from the retail store back to the original sender business of the box, or they may sell it to a ‘recyclable box or cardboard or box place,’ or they may receive a partial or full payment for the box being sent back to the (e.g., original business or a 3rd party buyer, or any buyer of folded or crushed box, etc.) In some embodiments, boxes may be returned or rebought as crushed or folded boxes. In some embodiments, there may be a process in which each box gets inspected by a human, a robot, computing software, or an AI that rates the box from a scale, and one side of the scale means it is ready to put another in it immediately. In some embodiments, the other side of the scale means it looks beat up. In some embodiments, a used or dirty item that may have been resold or used already can be placed in it or processed as recyclable or a 3rd party process. In some embodiments, boxes or boxes may be any (e.g., item, or any physical, or mental, idea or any product or idea or physical thing or human, robot, computing system, item, product, idea, or brain function, etc.)

In some embodiments, the application, app, or software allows users to (e.g., log in or create an account, or use a computing system through 3rd party or another app, etc.) In some embodiments, users can (e.g., see, be notified, etc.) (e.g., where, when, how, etc.) to (e.g., drop off their good condition box or pickup their box or item, etc.) by notification, bulletin, email, notification, and/or messages within the app or account. In some embodiments, the ‘good condition box return’ drop-off, pickup, foot traffic, foot, retail, or in-person location may change. In some embodiments, the retailer notifies, creates a business incentive for, or makes a deal with the application or business, whether manually or automatically through the application or software; thus, the application or software either manually or automatically promotes their in-person location to its consumers or registered users or email addresses or offers incentives or discount or coupon or credits on accounts, or shopping credits within that retail location only, or any retail location of that business or entity in return for users or persons or businesses to return box(es) to a retail location. In some embodiments, the (e.g., application or app, etc.) notifies (e.g., consumers or customers or registered users, etc.) where to return the box and what incentive they have for returning their box to the location, which may include but not be limited to (e.g., gift card, credits for makeup, credits for shopping, free hair conditioner, coupon, etc.) In some embodiments, the coupons or incentives may be time-limited or location-limited for the incentive to be utilized or credited to their account. In some embodiments, there may be an application or an app that the person who has the box may pull up and scan, for example, at a specific retail or partner location. In some embodiments, it may automatically add the discount, credit, or coupon to my application that can now be used to redeem through the retailer using only a specified code or QR code from my app that may show that you've been given the credit or the payment through the app.

In some embodiments, Computer-Implemented Method for Scheduling Item Pickups or Returns

Receiving User Input: In some embodiments, This method involves the reception of user input via a mobile application. Users specify the details of an item pickup or return, including the date, time, location, and item information. Information Storage: The received information about the scheduled item pickup or return is stored, ensuring critical scheduling data is retained for coordination.

Coordination with Logistics System: The method may include communicating the scheduled pickup or return details to a logistics system. In some embodiment, this communication facilitates efficient coordination of pickup or return services. In some embodiments, Confirmation Notifications: Confirmation notifications are sent to both the user and relevant service providers to confirm the details of the scheduled pickup or return. In some embodiment, this step enhances transparency and reliability. In some embodiments, Real-Time Tracking Feature: In addition to the steps outlined in some embodiments, this method provides users with a real-time tracking feature within the mobile application. In some embodiment, this feature allows users to monitor the status and location of the scheduled item pickup or return in real-time. User Modifications: The method enables users to change the scheduled pickup or return via the mobile application, including rescheduling or canceling. In some embodiment, this flexibility enhances user convenience. In some embodiments, Location-Based Services: This method utilizes location-based services to determine the user's current location. It automatically pre-fills pickup or return location fields within the mobile application, streamlining the scheduling process and reducing user effort. Mobile Application: The computer-implemented system may include a mobile application running on a user's mobile device. In some embodiments, This application is configured to receive and store input specifying the details of an item pickup or return and to communicate these details to a logistics system for coordination. Server System: Besides the mobile application, a server system is integrated into the system. In some embodiments, This server system communicates with both the mobile application and the logistics system. In some embodiments, It is configured to store and manage the scheduling information and generate confirmation notifications for users and service providers. Real-Time Tracking Module: A real-time tracking module is incorporated within the mobile application. In some embodiment, this module provides users with status and location updates of the scheduled item pickup or return, enhancing transparency and user satisfaction. User Interface Component: The mobile application may include a user interface component allowing users to change scheduled pickups or returns. In some embodiment, this component empowers users with control and flexibility.

Location-Based Services Module: A location-based services module is included within the mobile application. In some embodiment, this module is configured to automatically determine the user's current location and pre-fill pickup or return location fields. In some embodiment, this feature streamlines the scheduling process and minimizes user effort. Logistics System Functions: In addition to the features outlined in some embodiments, the logistics system is further configured to assign and dispatch pickup or return requests to designated service providers based on the scheduling information received from the mobile application. It also provides service providers access to scheduling information and navigation instructions to facilitate item pickups or returns, optimizing the logistics process. In some embodiments, the business or the app partners with the retailer specified per period or at the time, and we both go to the original box maker or box user and sell it back to them in almost good condition, and the proceeds or money is credited to a portion of each retailer and the business or the app per deal. In some embodiments, the buyer of the ‘good condition box’ can be any retailer, such as the retailer that the box is being returned to, or it can be an outside retailer, the original retailer, or the original sender with the item for the box. In some embodiments, the boxes may be held there at any retailer, location, storage unit, or storage facility for any other person to come in and get a free box to return their item. In some embodiments, there may be an application or a processor that allows a person, user, or the public to notify drivers, businesses, or entities that there are ten boxes, for example, waiting on the porch to be picked up that is in good shape and ready to go back and get another item it in rather than be broken down and recycled by the trash processor. In some embodiments, there may be an incentive of value for the person or entity to send the item back to the business or to place their gently used package boxes back outside to be picked up for free, or they may receive a discount or a credit on future purchases from the business for returning their boxes that may not have any flaws or are in pretty good shape. In some embodiments, they may return boxes or place them outside for free without incentive, get discounts or promotions on other items, etc.)

In some embodiments, there may be an application or a platform that allows people to notify the business or entity that there is a hotspot of people that have boxes ready to be picked up in a specific area, etc.) In some embodiments, the box may be sent back in the same or similar condition it was dropped off at or in a substantially non-designated box. In some embodiments, there may be a box drop-off site outside of an apartment, condo, housing unit, or business unit, where a person or a user may be able to drop off their gently used boxes. In some embodiments, AI may detect and notify businesses of how many boxes are at the drop-off point. In some embodiments, AI or computing software can dissect and decide (e.g., volume, number of boxes, weight, etc.) based on a picture or a video of the boxes (e.g., returning to box return in retail or any physical location, whether outside the patio waiting to be picked up, whether on a picture, a video, or a scan, etc.). In some embodiments, a (e.g., vicinity, picture visual or notification or visual or hotspot, or pictures, etc.) which may help (e.g., human or robots or computing software, etc.) determine or decide the (e.g., drop off frequency, arrangements, delivery or pickup arrangements, drop off arrangements, employee arrangements, pickup frequency, etc.) or how many customers have boxes within a certain vicinity, which may send specific pickup persons or arrangements for pickups.

In some embodiments, a live lottery ticket purchasing digital process is disclosed, involving a user interacting with a digital interface to initiate a live lottery ticket purchase. In some embodiment, a live video feed of a gas station attendant or representative, hereafter referred to as “Gas Station man or female,” is displayed on a screen, facilitating the physical acquisition of the lottery ticket on behalf of the user. In some embodiment, the live video feed is recorded in real-time, serving to authenticate and document the Gas Station Guy's procurement of the lottery ticket. In some embodiments, During the live video feed, the Gas Station Guy verbally announces the lottery ticket numbers to the user, enhancing transparency and user engagement. Following the live interaction, a digital receipt is generated and sent to the user, confirming the lottery ticket purchase. In some embodiments, The purchase is further verified by validating that the lottery ticket was physically printed at the gas station, ensuring a secure and auditable transaction. In some embodiments, the digital interface enabling user interaction with the live lottery ticket purchasing process may include a mobile application, website, or any electronic platform that facilitates remote participation, providing users with a convenient and accessible means of engaging in lottery ticket acquisition. In some embodiments, the live video feed is streamed in real-time, ensuring a contemporaneous and transparent experience for the user during the lottery ticket acquisition process. In some embodiment, this real-time streaming enhances the user's confidence in the integrity of the transaction.

In some embodiments, the process may include verifying the identity of the Gas Station Guy through biometric authentication, secure login credentials, or other authentication means. In some embodiment, this verification step ensures the integrity and authenticity of the lottery ticket acquisition process, preventing unauthorized access and enhancing overall security. In some embodiments, the digital receipt may include comprehensive details such as the lottery ticket numbers, date and time of purchase, and any additional relevant information regarding the lottery ticket transaction. In some embodiment, this detailed receipt provides users with a comprehensive record of their lottery ticket purchase. In some embodiments, the confirmation of the purchase involves a verification step to ensure that the lottery ticket was successfully printed at the gas station following the live video feed interaction. In some embodiment, this verification adds an additional layer of assurance regarding the completion of the lottery ticket purchase. In some embodiments, the process may include storing the recorded live video feed and associated data in a secure database for auditing, authentication, and compliance purposes. In some embodiment, this secure storage ensures the availability of records for auditing, authentication, and compliance with regulatory requirements. In some embodiments, a computing system is configured to perform the live lottery ticket purchasing digital process, providing a technological infrastructure for implementing the innovative process of remotely acquiring lottery tickets with live video verification. In some embodiments, a non-transitory computer-readable storage medium stores instructions that, when executed by a processor, cause the processor to perform the live lottery ticket purchasing digital process, offering a tangible embodiment of the described computing process for remote lottery ticket acquisition with live video verification.

In some embodiments, the platform or business may partner with a retailer or a business or company and offer a person or business (e.g., credits, money, gift card, etc.) in exchange for that person dropping off their boxes at a specified location or arranging a pickup. In some embodiment, the platform or business gets a percentage of money, payment, or partial payment in exchange for the foot traffic and the new business from the box drop-off. In some embodiments, when the person goes to return or give the used or gently used box, the retailer or business may provide that person a coupon or credit to their (e.g., digital, digital platform, account, etc.), such as by scanning a QR code. In some embodiments, the platform may be directly connected to the retailer or business app to which the coupon will be loaded or credited. In some embodiments, the user or user's assistants or robots (e.g., record information, take photos or videos, etc.) of the boxes or packages. In some embodiments, the (e.g., ‘proof’ or ‘media’ or information, etc.) uploads to a computing system or is evaluated by the account or platform to (e.g., create the next step, make another step or assessed by the software for a process or uploading information, etc.) In some embodiments, the business (e.g., evaluates the information, ai evaluates or estimates, or analyzes the data, sees the boxes, etc.) and or (e.g., schedules pickup or drop off, goes to a location, location is revealed, etc.) and once the boxes are (e.g., picked up, shown, returned, bought, dropped off, etc.) they may be (e.g., scanned or a picture is taken or information is taken, or an evaluation is done, etc.) by a computing system and or (e.g., incentivized goods or services or coupons or credits, or credit from the business or platform may be credited to the account of the box returner or a coupon, voucher, or an incentive, etc.)

Receiving User Input: In some embodiments, the computer-implemented method involves the reception of user input through a mobile application. In some embodiments, This input signifies the user's intention to return an item to a specific physical retail store location. Determining User Location: In some embodiments, The method may include a step for determining the geographical location of the user's mobile device, which serves as a crucial factor in streamlining the return process. Identifying Nearest Store: Following the determination of the user's mobile device location, the system identifies the nearest physical retail store location of the specified store. In some embodiments, this location identification ensures that the return process is directed to the store that is most convenient for the user. In some embodiments, providing comprehensive return instructions involves providing the user with detailed return instructions. In some embodiments, These instructions encompass essential information such as the store's location, the applicable return policy, and any necessary documentation required for facilitating the return at the identified nearest physical retail store. In some embodiments, Generating Return Authorization Barcode or QR Code: A return authorization barcode or QR code is generated specifically for the identified nearest physical retail store within the mobile application. In some embodiments, this code serves as a digital authorization for the return process. In some embodiments, Transmitting Generated Barcode/QR Code: The method may include a step where the generated return authorization barcode or QR code is transmitted to the user's mobile device. In some embodiments, This transmission ensures that the user possesses the necessary digital authorization for the return. In some embodiments, User Presentation at Physical Store: To facilitate the return process, the method allows the user to present the generated barcode or QR code at the identified nearest physical retail store. In some embodiments, This action initiates the return processing of the item, ensuring a seamless user experience. In some embodiments, Method with Additional Features]Receiving Item Information: In addition to the steps outlined in some embodiments, this method further comprises receiving detailed information about the item to be returned via the mobile application. In some embodiments, his information may include specifics such as product details, purchase date, and the reason for return. Information Storage: In some embodiments, The method involves storing the received information about the item to be returned within the mobile application. In some embodiment, this stored data serves as a reference point during the return process, aiding in efficient processing. User Eligibility Verification: In some embodiments, To ensure compliance with the specified store's return policy, the method may include a step where the system verifies the user's eligibility for return based on the provided information about the item to be returned. In some embodiment, this verification step is crucial for a successful return process.

In some embodiments, Account Update: In addition to the steps outlined in any of the embodiments described in this disclosure, this method may include the feature of updating the user's account with pertinent information about the return. Such information encompasses the return date, store location, and any details related to refunds or exchanges, thus maintaining a comprehensive record of the return. Confirmation Notification: Upon successfully completing the return process, a confirmation notification is sent to the user's mobile device. In some embodiment, this notification assures the user that the return has been successfully processed in some embodiments. Mobile Application: In some embodiments, The computer-implemented system comprises a mobile application running on a user's mobile device. In some embodiments, This application is designed to receive user input indicating the intention to return an item to a specific physical retail store location. Server System: In some embodiments, The system is further comprised of a server system in communication with the mobile application. In some embodiments, This server system is configured to perform critical tasks such as determining the user's current location, identifying the nearest physical retail store location of the specified store, and providing comprehensive return instructions.

Barcode/QR Code Generator Module: In some embodiments, within the mobile application, a specialized module is integrated to generate a return authorization barcode or QR code tailored for the identified nearest physical retail store.

Communication Module: The system may include a communication module within the mobile application to ensure the user possesses the necessary return authorization. In some embodiments, This module transmits the generated barcode or QR code to the user's mobile device.

Barcode/QR Code Reader: To initiate the return process at the physical retail store, a dedicated barcode or QR code reader is installed. In some embodiments, This reader is configured to scan the generated barcode or QR code presented by the user. Database:

In some embodiments, The system may include a database designed to store comprehensive information about items to be returned. In some embodiments, This information encompasses details such as product specifics, purchase date, and the reason for return. Verification Module: In some embodiments, A verification module is incorporated within the server system to ensure the user's eligibility for return by aligning with the specified store's return policy. In some embodiments, This verification is based on the information about the item to be returned stored in the database. In some embodiment, account Management Module: Within the server system, an account management module is integrated to maintain and update the user's account. In some embodiments, This module is responsible for updating the account with pertinent information about the return, including the return date, store location, and any details related to refunds or exchanges, ensuring accurate records. Notification Module: To provide the user with confirmation and peace of mind, a notification module within the server system is configured to send a confirmation notification to the user's mobile device once the return has been successfully processed. In some embodiments, This notification enhances the overall user experience.

Receiving User Input: In some embodiments, The computer-implemented method involves the reception of user input through a mobile application. In some embodiment, this input signifies the user's intention to return an item to a specific physical retail store location. Determining User Location: The method may include a step for determining the geographical location of the user's mobile device, which serves as a crucial factor in streamlining the return process. In some embodiments, Identifying Nearest Store: Following the determination of the user's mobile device location, the system identifies the nearest physical retail store location of the specified store. In some embodiments, this location identification ensures that the return process is directed to the store that is most convenient for the user. Providing Comprehensive Return Instructions: The method involves providing the user with detailed return instructions. In some embodiments, These instructions encompass essential information such as the store's location, the applicable return policy, and any necessary documentation required for facilitating the return at the identified nearest physical retail store. Generating Return Authorization Barcode or QR Code: Within the mobile application, a return authorization barcode or QR code is generated specifically for the identified nearest physical retail store. In some embodiment, this code serves as a digital authorization for the return process. Transmitting Generated Barcode/QR Code: In some embodiments, The method may include a step where the generated return authorization barcode or QR code is transmitted to the user's mobile device. In some embodiments, This transmission ensures that the user possesses the necessary digital authorization for the return.

In some embodiments, User Presentation at Physical Store: To facilitate the return process, the method allows the user to present the generated barcode or QR code at the identified nearest physical retail store. In some embodiments, This action initiates the return processing of the item, ensuring a seamless user experience. Receiving Item Information: In addition to the steps outlined in some embodiments, this method further comprises receiving detailed information about the item to be returned via the mobile application. In some embodiments, This information may include specifics such as product details, purchase date, and the reason for return. Information Storage: In some embodiments, The method involves storing the received information about the item to be returned within the mobile application. In some embodiments, This stored data serves as a reference point during the return process, aiding in efficient processing. User Eligibility Verification: To ensure compliance with the specified store's return policy, the method may include a step where the system verifies the user's eligibility for return based on the provided information about the item to be returned. In some embodiments, This verification step is crucial for a successful return process. In some embodiment, account Update: In addition to the steps outlined in any of the embodiments described in this disclosure, this method may include the feature of updating the user's account with pertinent information about the return. In some embodiments, Such information encompasses the return date, store location, and any details related to refunds or exchanges, thus maintaining a comprehensive record of the return. In some embodiments, Confirmation Notification: Upon successfully completing the return process, a confirmation notification is sent to the user's mobile device. In some embodiment, this notification assures the user that the return has been successfully processed.

In some embodiments, The computer-implemented system comprises a mobile application running on a user's mobile device. In some embodiment, this application is designed to receive user input indicating the intention to return an item to a specific physical retail store location. Server System: The system is further comprised of a server system communicating with the mobile application. In some embodiments, This server system is configured to perform critical tasks such as determining the user's current location, identifying the nearest physical retail store location of the specified store, and providing comprehensive return instructions.

Barcode/QR Code Generator Module: In some embodiments, Within the mobile application, a specialized module is integrated to generate a return authorization barcode or QR code tailored for the identified nearest physical retail store. In some embodiments, Communication Module: To ensure the user possesses the necessary return authorization, the system may include a communication module within the mobile application. In some embodiments, This module is responsible for transmitting the generated barcode or QR code to the user's mobile device. In some embodiments, a barcode or QR code operation may alternatively refer to or include any short-range or long-range wireless transmission operation.

Barcode/QR Code Reader: In some embodiments, a dedicated barcode or QR code reader is installed to initiate the return process at the physical retail store. In some embodiment, this reader is configured to scan the generated barcode or QR code presented by the user. Database: In some embodiments, The system may include a database designed to store comprehensive information about items to be returned. In some embodiments, This information encompasses details such as product specifics, purchase date, and the reason for return. Verification Module: A verification module is incorporated within the server system to ensure the user's eligibility for return by aligning with the specified store's return policy. In some embodiments, This verification is based on the information about the item to be returned stored in the database. In some embodiment, an Account Management Module: Within the server system, an account management module is integrated to maintain and update the user's account. In some embodiments, This module is responsible for updating the account with pertinent information about the return, including the return date, store location, and any details related to refunds or exchanges, ensuring accurate records. Notification Module: In some embodiments, To provide the user with confirmation and peace of mind, a notification module within the server system is configured to send a confirmation notification to the user's mobile device once the return has been successfully processed. In some embodiment, this notification enhances the overall user experience.

In some embodiments, Receiving User Input involves receiving user input via a mobile application. Users specify the details of an item pickup or return, including the date, time, location, and item information. Information Storage: In some embodiments, The received information about the scheduled item pickup or return is stored, ensuring that critical scheduling data is retained for coordination.

Coordination with Logistics System: In some embodiments, The method may include the crucial step of communicating the scheduled pickup or return details to a logistics system. In some embodiment, this communication facilitates efficient coordination of pickup or return services. Confirmation Notifications: In some embodiments, Confirmation notifications are sent to both the user and relevant service providers to confirm the details of the scheduled pickup or return. In some embodiment, this step enhances transparency and reliability. In some embodiments, Real-Time Tracking Feature: In addition to the steps outlined in any of the embodiments described in this disclosure, this method provides users with a real-time tracking feature within the mobile application. In some embodiment, this feature allows users to monitor the status and location of the scheduled item pickup or return in real-time. In some embodiments, User Modifications: The method allows users to make changes to the scheduled pickup or return, including rescheduling or canceling, via the mobile application. In some embodiments, This flexibility enhances user convenience. Location-Based Services: This method utilizes location-based services to determine the user's current location. It automatically pre-fills pickup or return location fields within the mobile application, streamlining the scheduling process and reducing user effort. Mobile Application: The computer-implemented system may include a mobile application running on a user's mobile device. In some embodiment, this application is configured to receive and store input specifying the details of an item pickup or return and to communicate these details to a logistics system for coordination. Server System: In addition to the mobile application, a server system is integrated into the system. In some embodiment, this server system is in communication with both the mobile application and the logistics system. It is configured to store and manage the scheduling information and generate confirmation notifications for users and service providers.

In some embodiments, Real-Time Tracking Module: A real-time tracking module is incorporated within the mobile application. In some embodiments, This module provides users with status and location updates of the scheduled item pickup or return, enhancing transparency and user satisfaction. User Interface Component: In some embodiments, The mobile application may include a user interface component that allows users to make changes to scheduled pickups or returns. T in some embodiments, his component empowers users with control and flexibility. Location-Based Services Module: A location-based services module is included within the mobile application. In some embodiments, This module is configured to determine the user's current location and pre-fill pickup or return location fields automatically. In some embodiments, This feature streamlines the scheduling process and minimizes user effort. Logistics System Functions: In addition to the features outlined in some embodiments, the logistics system is further configured to assign and dispatch pickup or return requests to designated service providers based on the scheduling information received from the mobile application. In some embodiments, It also provides service providers with access to scheduling information and navigation instructions to facilitate item pickups or returns, optimizing the logistics process.

In some embodiments, a computing system where users input their location or the computing system can see their location automatically regardless of their location. Their location can be changed, or the range can be changed or set to different distances, cities, or locations. The user is being shown local or targeted advertisements to show what ‘food there is to eat nearby’ or ‘events that are nearby’ based on video, virtual, live shows, projections, hologram advertisements, projection screens, etc. In some embodiments, the user can tell the computing device or personal device or technology what they want to eat, and it will show advertisements based on their preferences, the advertisements may be catered to each person by another live user at the restaurant answering questions, or it may be to book or set reservations, or it may be pre-recorded or made advertisements directly to the user's computing device. In some embodiments, the user may use this technology system to see what food or events are nearby and be shown video advertisements rather than pictures or having to click around. In some embodiments, advertisements may be shown, or voice commanded. For example, if a user wants to see another ad, it may switch to the next one based on voice commands or any command. In some embodiments, the user may be able to ask artificial intelligence in the system or with the system questions about the menu items, the restaurant, the parking, the lot, the location, the event, etc., and the user may be able to hear the responses from their voice or the system's voice or video shown responses rather than text. In some embodiments, the computing system described herein comprises a location detection module designed to determine a user's current location or receive a user-inputted location. The location detection module may utilize various technologies, including but not limited to global positioning system (GPS) technology, Wi-Fi triangulation, cellular tower triangulation, or a combination thereof.

In some embodiments, the computing system further includes a database containing comprehensive information about local food spots, encompassing grocery stores, hidden restaurants, small or large restaurants, local events, and local shows. This database forms a crucial aspect of the system, serving as a repository for the data used by subsequent modules for generating personalized advertisements.

In some embodiments, an advertisement generation module is integrated into the computing system. This module is configured to generate advertisements based on the user's current location or the inputted location. The generated advertisements include relevant information about local food spots, events, and shows retrieved from the database. Furthermore, in certain embodiments, the advertisement generation module prioritizes advertisements based on user preferences, popularity of local food spots, or proximity to the user's location.

In some embodiments, the computing system comprises a user interface allowing users to input preferences for local food spots, events, or shows. This user interface facilitates the customization of the advertisements generated by taking into consideration the individual preferences of the user.

In some embodiments, the computing system is equipped with a display module. The display module is configured to present the generated advertisements to the user, ensuring effective communication of the information related to local food spots, events, and shows.

In some embodiments, the computing system incorporates a feedback mechanism. This mechanism allows users to provide feedback on the relevance and satisfaction of presented advertisements. The feedback collected is subsequently utilized to enhance the accuracy of future advertisement generation, contributing to a more personalized user experience.

In some embodiments, the method for providing location-based advertising, involves detecting a user's current location or receiving a user-inputted location. Subsequently, the method includes accessing a database containing information about local food spots, events, and shows and generating advertisements based on the user's location or inputted location. These advertisements are then presented to the user, facilitating an interactive and location-aware advertising experience.

In some embodiments, the method takes into account the user's preferences for local food spots, events, or shows during the generation of advertisements. This ensures a more tailored and personalized advertising approach.

In some embodiments, the method prioritizes advertisements based on user preferences, popularity of local food spots, or proximity to the user's location. This prioritization contributes to the effectiveness of the advertisements in capturing the user's attention and interest.

In some embodiments, the method involves updating the database with information about new local food spots, events, and shows. Additionally, the method dynamically adjusts generated advertisements based on the updated information, ensuring that the advertising content remains current and relevant to the user.

A computing system comprising: a location detection module configured to determine a user's current location or receive a user-inputted location; a database containing information about local food spots, including grocery stores, hidden restaurants, small or large restaurants, local events, and local shows; an advertisement generation module configured to generate advertisements based on the user's current location or the inputted location, wherein the advertisements include information about local food spots, events, and shows from the database; and a display module configured to present the generated advertisements to the user.

The computing system as described in this disclosure, wherein the location detection module utilizes global positioning system (GPS) technology, Wi-Fi triangulation, cellular tower triangulation, or a combination thereof to determine the user's current location.

The computing system as described in this disclosure, further comprising a user interface allowing the user to input preferences for local food spots, events, or shows, wherein the advertisement generation module considers the user's preferences in generating advertisements.

The computing system as described in this disclosure, wherein the advertisement generation module prioritizes advertisements based on user preferences, popularity of local food spots, or proximity to the user's location.

The computing system as described in this disclosure, wherein the database is regularly updated with information about new local food spots, events, and shows, and wherein the advertisement generation module dynamically adjusts generated advertisements based on the updated information.

The computing system as described in this disclosure, further comprising a feedback mechanism allowing users to provide feedback on the relevance and satisfaction of presented advertisements, wherein the feedback is used to improve the accuracy of future advertisement generation.

A method for providing location-based advertising for local food spots, events, and shows, comprising: detecting a user's current location or receiving a user-inputted location; accessing a database containing information about local food spots, including grocery stores, hidden restaurants, small or large restaurants, local events, and local shows; generating advertisements based on the user's current location or the inputted location, wherein the advertisements include information about local food spots, events, and shows from the database; and presenting the generated advertisements to the user.

The method of any of the embodiments described in this disclosure, wherein the user's preferences for local food spots, events, or shows are considered in the generation of advertisements.

The method of any of the embodiments described in this disclosure, wherein the advertisements are prioritized based on user preferences, popularity of local food spots, or proximity to the user's location.

The method of any of the embodiments described in this disclosure, further comprising updating the database with information about new local food spots, events, and shows, and dynamically adjusting generated advertisements based on the updated information.

A virtual streaming computing system where users can view advertisements based on their current geographical location.

A method or system relating to a Computing Process for Ad Viewing on Personal Devices, where multiple participants, including customers, humans, robots, and individuals, can stand and view advertisements displayed on computing devices:
a. Computing Process: This disclosure encompasses the disclosed computing process designed to facilitate the viewing of advertisements on personal devices.
b. Multiple Participants: The disclosure specifies that the process accommodates multiple participants, including customers, humans, robots, and individuals.
c. Screen-Based Viewing: The process allows participants to gather around and watch advertisements displayed on a screen of a computing device.
d. In some embodiment, advertisements on Personal Devices: It further emphasizes that the advertisements being viewed are presented on the personal devices or phones of the individuals participating in the process.

A method or system elaborating on the Real-Time Ad Display Process:
a. Real-Time Ad Display: This disclosure highlights the real-time nature of the ad display process, indicating that advertisements are shown as they are being viewed by other participants.
b. Simultaneous Viewing: It emphasizes that multiple participants can simultaneously view advertisements on their respective personal devices while observing the same content.

A method or system emphasizing User Interaction with Ad Content:
a. User Interaction: This part of the disclosure underscores that participants can interact with the displayed advertisements on their personal devices, including but not limited to actions such as liking, sharing, or providing feedback.
b. Personalized Engagement: It highlights the capability of the process to tailor ad content based on user interactions, providing a personalized advertising experience.

A method or system introducing Advertisement Synchronization:

Advertisement Synchronization: This disclosure introduces the concept of synchronization, where the process coordinates the timing and content of advertisements across the personal devices of participants for a cohesive viewing experience.

A method or system relating to Advertisement Selection:

Advertisement Selection: This disclosure outlines the process's ability to select advertisements based on various factors, including participant preferences, demographics, and contextual relevance.

A method or system on Data Analytics for Ad Performance Assessment:

Data Analytics Integration: This disclosure underscores the incorporation of data analytics capabilities within the process, which assess and analyze the performance of displayed advertisements, including metrics such as engagement, viewership, and conversion rates.

A method or system focusing on Participant Privacy and Consent:

Privacy Measures: This part of the disclosure emphasizes the implementation of privacy measures to ensure that participant data and personal device usage adhere to applicable privacy regulations and consent standards.

A method or system concerning Interactivity Features:

Enhanced Interactivity: This disclosure introduces enhanced interactivity features, such as live polling or quizzes related to the displayed advertisements, allowing participants to actively engage with the content.

A method or system emphasizing Device Compatibility:

Device Compatibility: This disclosure highlights that the process is compatible with a wide range of personal devices, including smartphones, tablets, laptops, and other computing devices.

A method or system reiterating the Multifunctionality of the Process:

Multifunctionality: This disclosure reiterates that the computing process is multifunctional, serving as a platform not only for ad viewing but also for interactive engagement, data analytics, and synchronized content delivery to multiple participants.

A method or system related to a Mobile Ad Viewing Computing Process, where individuals, whether sitting, moving, or walking, can watch advertisements on their personal devices while on the move:
a. Mobile Ad Viewing: This disclosure encompasses the disclosed computing process designed to facilitate the viewing of advertisements on personal devices while individuals are mobile.
b. Inclusive of Various Activities: The disclosure specifies that the process accommodates individuals engaged in various activities, whether they are sitting, moving (e.g., using public transportation), or walking.
c. Display on Personal Devices: The process allows participants to watch advertisements displayed on the screens of their personal devices or phones while being mobile.

A method or system emphasizing the Real-Time Mobile Ad Display Process:
a. Real-Time Ad Display: This disclosure highlights the real-time nature of the ad display process, indicating that advertisements are shown as they are being viewed by other participants, regardless of their mobility.
b. Simultaneous Viewing: It emphasizes that multiple individuals can simultaneously view advertisements on their respective personal devices while being mobile and engaged in various activities.

A method or system underlining User Interaction with Ad Content while on the move:
a. User Interaction: This part of the disclosure underscores that individuals can interact with the displayed advertisements on their personal devices, including actions such as liking, sharing, or providing feedback, even while they are on the move.
b. Personalized Engagement: It highlights the capability of the process to tailor ad content based on user interactions, providing a personalized advertising experience, whether individuals are sitting, moving, or walking.

A method or system introducing Advertisement Synchronization for Mobile Participants:

In some embodiment, advertisement Synchronization: This disclosure introduces the concept of synchronization, where the process coordinates the timing and content of advertisements across the personal devices of mobile participants to ensure a cohesive viewing experience.

A method or system relating to Mobile Advertisement Selection:

In some embodiment, advertisement Selection: This disclosure outlines the process's ability to select advertisements based on various factors, including participant preferences, demographics, and contextual relevance, regardless of their mobility.

A method or system on Data Analytics for Ad Performance Assessment while individuals are on the move:
a. Data Analytics Integration: This disclosure underscores the incorporation of data analytics capabilities within the process, which assess and analyze the performance of displayed advertisements, including metrics such as engagement, viewership, and conversion rates, even when individuals are mobile.

A method or system focusing on Participant Privacy and Consent, irrespective of their mobility:

Privacy Measures: This part of the disclosure emphasizes the implementation of privacy measures to ensure that participant data and personal device usage adhere to applicable privacy regulations and consent standards, regardless of whether individuals are sitting, moving, or walking.

A method or system concerning Interactivity Features for Mobile Users:

Enhanced Interactivity: This disclosure introduces enhanced interactivity features, such as live polling or quizzes related to the displayed advertisements, allowing individuals to actively engage with the content even while they are on the move.

A method or system emphasizing Device Compatibility for Mobile Participants:

Device Compatibility: This disclosure highlights that the process is compatible with a wide range of personal devices, including smartphones, tablets, wearables, and other mobile computing devices, catering to individuals engaged in different activities and mobility levels.

A method or system reiterating the Multifunctionality of the Mobile Ad Viewing Process:

Multifunctionality: This disclosure reiterates that the mobile computing process is multifunctional, serving as a platform not only for ad viewing but also for interactive engagement, data analytics, and synchronized content delivery to multiple mobile participants, regardless of their activities and mobility.

A method or system related to a Mobile Ad Viewing Computing Process during Delivery Services, where individuals, whether standing, sitting, walking, or moving, can watch advertisements on their personal devices while utilizing a delivery service:
a. Mobile Ad Viewing: This disclosure encompasses the disclosed computing process designed to facilitate the viewing of advertisements on personal devices while individuals are engaged in delivery services.
b. Inclusive of Various Activities: The disclosure specifies that the process accommodates individuals engaged in various activities, whether they are standing, sitting, walking, or moving, and allows them to watch advertisements on their personal devices.
c. Display on Personal Devices: The process enables participants to watch advertisements displayed on the screens of their personal devices or phones while utilizing a delivery service.

A method or system emphasizing the Real-Time Mobile Ad Display Process during Delivery Services:
a. Real-Time Ad Display: This disclosure highlights the real-time nature of the ad display process, indicating that advertisements are shown as they are being viewed by other participants during delivery services, regardless of their activity or mobility.
b. Simultaneous Viewing: It emphasizes that multiple individuals can simultaneously view advertisements on their respective personal devices while engaging in various delivery-related activities.

A method or system underlining User Interaction with Ad Content during Delivery Services:

User Interaction: This part of the disclosure underscores that individuals can interact with the displayed advertisements on their personal devices while participating in delivery services, including actions such as liking, sharing, or providing feedback.
b. Personalized Engagement: It highlights the capability of the process to tailor ad content based on user interactions during delivery services, providing a personalized advertising experience.

A method or system introducing Advertisement Synchronization for Participants during Delivery Services:
a. In some embodiment, advertisement Synchronization: This disclosure introduces the concept of synchronization, where the process coordinates the timing and content of advertisements across the personal devices of participants during delivery services to ensure a cohesive viewing experience.

A method or system relating to Mobile Advertisement Selection during Delivery Services:

In some embodiment, advertisement Selection: This disclosure outlines the process's ability to select advertisements during delivery services based on various factors, including participant preferences, demographics, and contextual relevance.

A method or system on Data Analytics for Ad Performance Assessment during Delivery Services:

Data Analytics Integration: This disclosure underscores the incorporation of data analytics capabilities within the process, which assess and analyze the performance of displayed advertisements during delivery services, including metrics such as engagement, viewership, and conversion rates.

A method or system focusing on Participant Privacy and Consent during Delivery Services:

Privacy Measures: This part of the disclosure emphasizes the implementation of privacy measures during delivery services to ensure that participant data and personal device usage adhere to applicable privacy regulations and consent standards.

A method or system concerning Interactivity Features for Participants during Delivery Services:

Enhanced Interactivity: This disclosure introduces enhanced interactivity features during delivery services, allowing individuals to actively engage with the content on their personal devices, enhancing the overall delivery experience.

A method or system emphasizing Device Compatibility for Participants during Delivery Services:

Device Compatibility: This disclosure highlights that the process is compatible with a wide range of personal devices, including smartphones, tablets, wearables, and other mobile computing devices, catering to individuals participating in delivery services.

A method or system reiterating the Multifunctionality of the Mobile Ad Viewing Process during Delivery Services:

Multifunctionality: This disclosure reiterates that the mobile computing process is multifunctional during delivery services, serving as a platform not only for ad viewing but also for interactive engagement, data analytics, and synchronized content delivery to multiple participants, regardless of their activities and mobility.

A method or system for an Interactive Ad Viewing Process during Order Placement, enabling users, whether they are customers, humans, robots, or persons, to watch advertisements on their personal devices while initiating an order:
a. Interactive Ad Viewing: This disclosure encompasses the disclosed computing process designed to facilitate the interactive viewing of advertisements on personal devices while individuals are engaged in placing an order.
b. User Flexibility: The disclosure specifies that the process accommodates various users, whether they are customers, humans, robots, or persons, allowing them to watch advertisements on their personal devices.
c. Simultaneous Ad Display: The process ensures that advertisements are displayed in real-time on personal devices while users are placing orders.

A method or system highlighting the Real-Time Ad Display Process during Order Placement:
a. Real-Time Ad Display: This disclosure underscores the real-time nature of the ad display process, indicating that advertisements are shown as they are being viewed by users during order placement.
b. Multiple User Engagement: It emphasizes that multiple users can simultaneously view advertisements on their respective personal devices while initiating orders.

A method or system underlining User Interaction with Ad Content during Order Placement:
a. User Interaction: This part of the disclosure emphasizes that users can interact with the displayed advertisements on their personal devices while placing orders, including actions such as liking, sharing, or providing feedback.
b. Personalized Engagement: It highlights the capability of the process to tailor ad content based on user interactions during order placement, providing a personalized advertising experience.

A method or system introducing Advertisement Synchronization for Users during Order Placement:

In some embodiment, advertisement Synchronization: This disclosure introduces the concept of synchronization, where the process coordinates the timing and content of advertisements across the personal devices of users during order placement to ensure a cohesive viewing experience.

A method or system relating to Mobile Advertisement Selection during Order Placement:

In some embodiment, advertisement Selection: This disclosure outlines the process's ability to select advertisements during order placement based on various factors, including user preferences, demographics, and contextual relevance.

A method or system on Data Analytics for Ad Performance Assessment during Order Placement:

Data Analytics Integration: This disclosure underscores the incorporation of data analytics capabilities within the process, which assess and analyze the performance of displayed advertisements during order placement, including metrics such as engagement, viewership, and conversion rates.

A method or system focusing on User Privacy and Consent during Order Placement:

Privacy Measures: This part of the disclosure emphasizes the implementation of privacy measures during order placement to ensure that user data and personal device usage adhere to applicable privacy regulations and consent standards.

A method or system concerning Interactivity Features for Users during Order Placement:

Enhanced Interactivity: This disclosure introduces enhanced interactivity features during order placement, allowing users to actively engage with the content on their personal devices, enhancing the overall ordering experience.

A method or system emphasizing Device Compatibility for Users during Order Placement:

Device Compatibility: This disclosure highlights that the process is compatible with a wide range of personal devices, including smartphones, tablets, wearables, and other mobile computing devices, catering to users placing orders.

A method or system reiterating the Multifunctionality of the Interactive Ad Viewing Process during Order Placement:

Multifunctionality: This disclosure reiterates that the interactive computing process is multifunctional during order placement, serving as a platform not only for ad viewing but also for interactive engagement, data analytics, and synchronized content delivery to multiple users during the order placement process.

A method or system for an Interactive Ad-Watching Process during Order Placement and Payment Waiver, facilitating users, including customers, humans, robots, or persons, to watch advertisements on their personal devices instead of making a payment when placing an order:
a. Interactive Ad Viewing: This disclosure encompasses the disclosed computing process designed to enable interactive viewing of advertisements on personal devices while individuals are placing an order.
b. Payment Waiver: The disclosure specifies that the process allows users to forgo the traditional payment process and, instead, watch advertisements on their personal devices as a means of covering the order's cost.
c. User Flexibility: The process accommodates various users, including customers, humans, robots, or persons, allowing them to watch advertisements on their personal devices and complete orders without monetary payments.

A method or system highlighting the Real-Time Ad Display Process during Order Placement with Payment Waiver:
a. Real-Time Ad Display: This disclosure underscores the real-time nature of the ad display process, indicating that advertisements are shown as users are placing orders and opting for the payment waiver through ad-watching.
b. Payment-Free Transactions: It emphasizes that users can complete transactions without making traditional monetary payments, relying solely on watching advertisements on their personal devices.

A method or system underlining User Interaction with Ad Content during Order Placement and Payment Waiver:
a. User Interaction: This part of the disclosure emphasizes that users can interact with the displayed advertisements on their personal devices while placing orders and opting for payment waiver, including actions such as liking, sharing, or providing feedback.
b. Personalized Engagement: It highlights the capability of the process to tailor ad content based on user interactions during order placement, providing a personalized advertising experience in exchange for waiving payment.

A method or system introducing Advertisement Synchronization for Users during Order Placement and Payment Waiver:

In some embodiment, advertisement Synchronization: This disclosure introduces the concept of synchronization, where the process coordinates the timing and content of advertisements across the personal devices of users during order placement with payment waiver to ensure a cohesive viewing experience.

A method or system relating to Mobile Advertisement Selection during Order Placement and Payment Waiver:

In some embodiment, advertisement Selection: This disclosure outlines the process's ability to select advertisements during order placement and payment waiver based on various factors, including user preferences, demographics, and contextual relevance.

A method or system on Data Analytics for Ad Performance Assessment during Order Placement and Payment Waiver:

Data Analytics Integration: This disclosure underscores the incorporation of data analytics capabilities within the process, which assess and analyze the performance of displayed advertisements during order placement with payment waiver, including metrics such as engagement, viewership, and conversion rates.

A method or system focusing on User Privacy and Consent during Order Placement and Payment Waiver:

Privacy Measures: This part of the disclosure emphasizes the implementation of privacy measures during order placement with payment waiver to ensure that user data and personal device usage adhere to applicable privacy regulations and consent standards.

A method or system concerning Interactivity Features for Users during Order Placement and Payment Waiver:

Enhanced Interactivity: This disclosure introduces enhanced interactivity features during order placement with payment waiver, allowing users to actively engage with the content on their personal devices while completing transactions without monetary payments.

A method or system emphasizing Device Compatibility for Users during Order Placement and Payment Waiver:

Device Compatibility: This disclosure highlights that the process is compatible with a wide range of personal devices, including smartphones, tablets, wearables, and other mobile computing devices, catering to users opting for payment waiver through ad-watching when placing orders.

A method or system reiterating the Multifunctionality of the Interactive Ad-Watching Process during Order Placement with Payment Waiver:

Multifunctionality: This disclosure reiterates that the interactive computing process is multifunctional during order placement with payment waiver, serving as a platform not only for ad viewing but also for interactive engagement, data analytics, and synchronized content delivery to multiple users completing transactions without making traditional payments.

A method or system for a Computing Process for Ad-Watching in Lieu of Tipping during Order Placement:
a. In some embodiment, a d-Watching Instead of Tipping: This disclosure encompasses the disclosed computing process that allows customers, humans, robots, or persons to watch advertisements on their personal devices when placing an order, as an alternative to traditional tipping for service.
b. User-Friendly Interface: The process provides a user-friendly interface for seamlessly opting for ad-watching instead of tipping while placing an order.
c. Enhanced Customer Experience: By replacing tipping with ad-watching, the process enhances the overall customer experience by offering a unique and interactive way for users to express appreciation to service providers.

A method or system focusing on Interactive Ad Engagement during Order Placement as a Tipping Substitute:
a. Interactive Ad Engagement: This disclosure highlights the interactive nature of the ad engagement during order placement, enabling users to actively interact with advertisements on their personal devices.
b. Real-Time Ad Display: The process ensures that advertisements are displayed in real-time as users place orders, providing a dynamic and engaging experience.

A method or system underscoring User Choice in Ad Selection during Order Placement:

In some embodiment, a d Selection: This disclosure outlines the process's capability to allow users to choose from a selection of advertisements that align with their preferences, interests, or demographics during order placement instead of tipping.

A method or system related to Data Analytics for Ad Performance Evaluation during Order Placement:

Data Analytics Integration: This part of the disclosure emphasizes the incorporation of data analytics capabilities within the process, which assess and analyze the performance of displayed advertisements during order placement, including metrics such as engagement, viewership, and conversion rates.

A method or system concerning Privacy and User Consent:

Privacy Measures: This disclosure specifies the implementation of privacy measures to ensure user data and personal device usage adhere to applicable privacy regulations and consent standards during order placement when opting for ad-watching instead of tipping.

A method or system emphasizing Device Compatibility:

Device Compatibility: This disclosure highlights that the process is compatible with a wide range of personal devices, including smartphones, tablets, wearables, and other mobile computing devices, allowing users to participate in ad-watching instead of tipping regardless of their chosen device.

A method or system reiterating the Multifunctionality of the Interactive Ad-Watching Process during Order Placement:

Multifunctionality: This disclosure reiterates that the interactive computing process is multifunctional during order placement, serving as a platform not only for ad viewing but also for interactive engagement, data analytics, and a tipping alternative for expressing gratitude to service providers.

A method or system focusing on Service Provider Compensation:

Compensation Mechanism: This disclosure outlines the compensation mechanism for service providers when customers, humans, robots, or persons choose ad-watching over traditional tipping during order placement.

A method or system highlighting Enhanced Customer Feedback:

Feedback Integration: The process integrates a feedback mechanism that enables users to provide feedback on the advertisements they watch during order placement, offering valuable insights for advertisers.

A method or system reiterating User Flexibility:

User Flexibility: This disclosure emphasizes that the process accommodates various users and provides them with flexibility in choosing between traditional tipping and ad-watching during order placement, enhancing their overall experience and engagement.

A method or system for a Computing Process for Ad-Watching in Lieu of Tipping during Order Receipt:
a. In some embodiment, a d-Watching Instead of Tipping: This disclosure encompasses the disclosed computing process that allows customers, humans, robots, or persons to watch advertisements on their personal devices or someone else's personal device when receiving an order, as an alternative to traditional tipping for service.
b. User-Friendly Interface: The process provides a user-friendly interface for seamlessly opting for ad-watching instead of tipping when receiving an order.
c. Enhanced Customer Experience: By replacing tipping with ad-watching, the process enhances the overall customer experience by offering a unique and interactive way for users to express appreciation to service providers.

A method or system focusing on Interactive Ad Engagement during Order Receipt as a Tipping Substitute:
a. Interactive Ad Engagement: This disclosure highlights the interactive nature of the ad engagement during order receipt, enabling users to actively interact with advertisements on their personal devices or someone else's personal device.
b. Real-Time Ad Display: The process ensures that advertisements are displayed in real-time as users receive orders, providing a dynamic and engaging experience.

A method or system underscoring User Choice in Ad Selection during Order Receipt:

In some embodiment, a d Selection: This disclosure outlines the process's capability to allow users to choose from a selection of advertisements that align with their preferences, interests, or demographics during order receipt instead of tipping.

A method or system related to Data Analytics for Ad Performance Evaluation during Order Receipt:
a. Data Analytics Integration: This part of the disclosure emphasizes the incorporation of data analytics capabilities within the process, which assess and analyze the performance of displayed advertisements during order receipt, including metrics such as engagement, viewership, and conversion rates.

A method or system concerning Privacy and User Consent:

Privacy Measures: This disclosure specifies the implementation of privacy measures to ensure user data and personal device usage adhere to applicable privacy regulations and consent standards during order receipt when opting for ad-watching instead of tipping.

A method or system emphasizing Device Compatibility:

Device Compatibility: This disclosure highlights that the process is compatible with a wide range of personal devices, including smartphones, tablets, wearables, and other mobile computing devices, allowing users to participate in ad-watching instead of tipping regardless of their chosen device.

A method or system reiterating the Multifunctionality of the Interactive Ad-Watching Process during Order Receipt:

Multifunctionality: This disclosure reiterates that the interactive computing process is multifunctional during order receipt, serving as a platform not only for ad viewing but also for interactive engagement, data analytics, and a tipping alternative for expressing gratitude to service providers.

A method or system focusing on Service Provider Compensation:

Compensation Mechanism: This disclosure outlines the compensation mechanism for service providers when customers, humans, robots, or persons choose ad-watching over traditional tipping during order receipt.

A method or system highlighting Enhanced Customer Feedback:

Feedback Integration: The process integrates a feedback mechanism that enables users to provide feedback on the advertisements they watch during order receipt, offering valuable insights for advertisers.

A method or system reiterating User Flexibility:

User Flexibility: This disclosure emphasizes that the process accommodates various users and provides them with flexibility in choosing between traditional tipping and ad-watching during order receipt, enhancing their overall experience and engagement.

A method or system for a Computing Process for Interactive Ad Engagement as Payment Replacement during Order Placement:
a. Interactive Ad Engagement Instead of Payment: This disclosure encompasses the disclosed computing process that allows customers, humans, robots, or persons to actively engage with interactive advertisements, such as questionnaires or information insertion, on their personal devices or someone else's personal device when placing an order, as an alternative to traditional payment methods.
b. User-Friendly Interface: The process provides a user-friendly interface for seamlessly opting for interactive ad engagement instead of making a payment when placing an order.
c. Enhanced Customer Experience: By replacing payment with interactive ad engagement, the process enhances the overall customer experience by offering a dynamic and participatory way for users to pay for goods or services.

A method or system emphasizing Real-Time Interactive Ad Display during Order Placement as a Payment Alternative:

Real-Time Interactive Ad Display: This disclosure highlights the real-time display of interactive advertisements, including questionnaires or information insertion, as users place orders, providing a dynamic and engaging experience.

A method or system underscoring User Choice in Ad Interaction during Order Placement:

Ad Interaction Choice: This disclosure outlines the process's capability to allow users to choose from various forms of interactive advertisements, including questionnaires or information insertion, that align with their preferences, interests, or demographics when placing an order instead of making a payment.

A method or system related to Data Analytics for Ad Interaction Performance Evaluation during Order Placement:

Data Analytics Integration: This part of the disclosure emphasizes the incorporation of data analytics capabilities within the process, which assess and analyze the performance of interactive ad engagement, including metrics such as user responses, completion rates, and conversion rates, during order placement.

A method or system concerning Privacy and User Consent:

Privacy Measures: This disclosure specifies the implementation of privacy measures to ensure user data and personal device usage adhere to applicable privacy regulations and consent standards when opting for interactive ad engagement as a payment alternative during order placement.

A method or system emphasizing Device Compatibility:

Device Compatibility: This disclosure highlights that the process is compatible with a wide range of personal devices, including smartphones, tablets, wearables, and other mobile computing devices, allowing users to participate in interactive ad engagement as a payment alternative regardless of their chosen device.

A method or system reiterating the Multifunctionality of the Interactive Ad Engagement Process during Order Placement:

Multifunctionality: This disclosure reiterates that the interactive computing process is multifunctional during order placement, serving as a platform not only for ad interaction but also for data analytics, feedback collection, and a payment alternative for goods or services.

A method or system focusing on Merchant Compensation:

Compensation Mechanism: This disclosure outlines the compensation mechanism for merchants or service providers when customers, humans, robots, or persons choose interactive ad engagement over traditional payment methods during order placement.

A method or system highlighting Enhanced Customer Feedback:

Feedback Integration: The process integrates a feedback mechanism that enables users to provide feedback on their interactive ad engagement experiences during order placement, offering valuable insights for advertisers and service providers.

A method or system reiterating User Flexibility:

User Flexibility: This disclosure emphasizes that the process accommodates various users and provides them with flexibility in choosing between traditional payment and interactive ad engagement during order placement, enhancing their overall experience and engagement.

A method or system for a Computing Process for Interactive Ad and Human Interaction as Gratuity Replacement during Order Delivery:

Interactive Ad and Human Interaction: This disclosure encompasses the disclosed computing process that allows customers, humans, robots, or persons to actively engage with interactive advertisements or live human representatives on a computing device, such as their personal device or someone else's personal device, when receiving an order as an alternative to traditional tipping.
b. Real-Time Interaction: The process enables real-time interaction between users and interactive ads or live human representatives, enhancing the experience during the order delivery process.
c. Enhanced Gratuity Experience: By replacing traditional tipping with interactive ad and human interaction, the process enhances the overall gratuity experience by offering a dynamic and participatory way for users to show appreciation for goods or services.

A method or system emphasizing User Choice in Interaction during Order Delivery:

Interaction Choice: This disclosure outlines the process's capability to allow users to choose from various forms of interaction, including engagement with interactive advertisements or live human representatives, that align with their preferences, interests, or demographics when receiving an order instead of tipping.

A method or system underscoring Real-Time Feedback and Evaluation Mechanism:

Feedback Mechanism: This part of the disclosure emphasizes the incorporation of a real-time feedback and evaluation mechanism within the process, which collects and analyzes user feedback, ratings, and comments related to the interactive ad and human interactions during order delivery.

A method or system related to Privacy and User Consent:

Privacy Measures: This disclosure specifies the implementation of privacy measures to ensure user data and personal device usage adhere to applicable privacy regulations and consent standards when opting for interactive ad and human interaction as a gratuity replacement during order delivery.

A method or system concerning Device Compatibility:

Device Compatibility: This disclosure highlights that the process is compatible with a wide range of personal devices, including smartphones, tablets, wearables, and other mobile computing devices, allowing users to participate in interactive ad and human interactions as a gratuity replacement regardless of their chosen device.

A method or system reiterating the Multifunctionality of the Interactive Interaction Process during Order Delivery:

Multifunctionality: This disclosure reiterates that the interactive computing process is multifunctional during order delivery, serving as a platform not only for ad interaction and human interaction but also for feedback collection, evaluation, and a gratuity alternative for goods or services.

A method or system focusing on Merchant Compensation:

Compensation Mechanism: This disclosure outlines the compensation mechanism for merchants or service providers when customers, humans, robots, or persons choose interactive ad and human interaction over traditional tipping during order delivery.

A method or system highlighting Enhanced Customer Feedback:

Feedback Integration: The process integrates a feedback mechanism that enables users to provide feedback on their interactive ad and human interaction experiences during order delivery, offering valuable insights for advertisers, service providers, and human representatives.

A method or system reiterating User Flexibility:

User Flexibility: This disclosure emphasizes that the process accommodates various users and provides them with flexibility in choosing between traditional tipping and interactive ad and human interaction during order delivery, enhancing their overall experience and engagement.

A method or system for a Computing Process for Interactive Gratuity Interaction during Order Placement:

Interactive Gratuity Interaction: This disclosure encompasses the disclosed computing process that allows customers, humans, robots, or persons to actively engage with interactive advertisements or live human representatives on a computing device, such as their personal device, during the order placement process as an alternative to traditional tipping.
b. Real-Time Interaction: The process enables real-time interaction between users and interactive ads or live human representatives, enhancing the order placement experience.
c. Enhanced Gratuity Experience: By replacing traditional tipping with interactive gratuity interaction, the process enhances the overall gratuity experience by offering a dynamic and participatory way for users to show appreciation for goods or services.

A method or system emphasizing User Choice in Interaction during Order Placement:

Interaction Choice: This disclosure outlines the process's capability to allow users to choose from various forms of interaction, including engagement with interactive advertisements or live human representatives, that align with their preferences, interests, or demographics when placing an order instead of tipping.

A method or system underscoring Real-Time Feedback and Evaluation Mechanism:

Feedback Mechanism: This part of the disclosure emphasizes the incorporation of a real-time feedback and evaluation mechanism within the process, which collects and analyzes user feedback, ratings, and comments related to the interactive gratuity interaction during order placement.

A method or system related to Privacy and User Consent:

Privacy Measures: This disclosure specifies the implementation of privacy measures to ensure user data and personal device usage adhere to applicable privacy regulations and consent standards when opting for interactive gratuity interaction as an alternative to tipping during order placement.

A method or system concerning Device Compatibility:

Device Compatibility: This disclosure highlights that the process is compatible with a wide range of personal devices, including smartphones, tablets, wearables, and other mobile computing devices, allowing users to participate in interactive gratuity interactions regardless of their chosen device.

A method or system reiterating the Multifunctionality of the Interactive Interaction Process during Order Placement:

Multifunctionality: This disclosure reiterates that the interactive computing process is multifunctional during order placement, serving as a platform not only for ad interaction and human interaction but also for feedback collection, evaluation, and a gratuity alternative for goods or services.

A method or system focusing on Merchant Compensation:

Compensation Mechanism: This disclosure outlines the compensation mechanism for merchants or service providers when customers, humans, robots, or persons choose interactive gratuity interaction over traditional tipping during order placement.

A method or system highlighting Enhanced Customer Feedback:

Feedback Integration: The process integrates a feedback mechanism that enables users to provide feedback on their interactive gratuity interaction experiences during order placement, offering valuable insights for advertisers, service providers, and human representatives.

A method or system reiterating User Flexibility:

User Flexibility: This disclosure emphasizes that the process accommodates various users and provides them with flexibility in choosing between traditional tipping and interactive gratuity interaction during order placement, enhancing their overall experience and engagement.

A method or system for a Computing Process for Interactive Order Payment Alternatives:

Interactive Order Payment Alternatives: This disclosure encompasses the disclosed computing process, allowing customers, humans, robots, or persons to actively engage with interactive advertisements, human representatives, or live persons on a computing device, such as their personal device, during the order placement process as a substitute for traditional payment methods.
b. Real-Time Interaction: The process enables real-time interaction between users and interactive ads, human representatives, or live persons, enhancing the order placement and payment experience.
c. Payment Alternative Selection: Users have the option to select interactive order payment alternatives, which may include answering questions, participating in surveys, watching ads, or engaging in other interactive activities as a means of settling their payment.

A method or system emphasizing User Choice in Payment Alternatives during Order Placement:

Payment Choice: This disclosure outlines the process's capability to allow users to choose from various payment alternatives, including engagement with interactive advertisements, human representatives, or live persons, that align with their preferences, interests, or demographics when placing an order instead of using conventional payment methods.

A method or system underscoring Real-Time Feedback and Evaluation Mechanism:

Feedback Mechanism: This part of the disclosure emphasizes the incorporation of a real-time feedback and evaluation mechanism within the process, which collects and analyzes user feedback, ratings, and comments related to the interactive order payment alternatives during order placement.

A method or system related to Privacy and User Consent:

Privacy Measures: This disclosure specifies the implementation of privacy measures to ensure user data and personal device usage adhere to applicable privacy regulations and consent standards when opting for interactive payment alternatives during order placement.

A method or system concerning Device Compatibility:

Device Compatibility: This disclosure highlights that the process is compatible with a wide range of personal devices, including smartphones, tablets, wearables, and other mobile computing devices, allowing users to participate in interactive payment alternatives regardless of their chosen device.

A method or system reiterating the Multifunctionality of the Interactive Payment Process during Order Placement:

Multifunctionality: This disclosure reiterates that the interactive computing process is multifunctional during order placement, serving as a platform not only for payment alternatives but also for feedback collection, evaluation, and engagement with advertisements, human representatives, or live persons.

A method or system focusing on Compensation and Transaction Settlement:

Compensation Mechanism: This disclosure outlines the compensation mechanism for merchants, advertisers, or service providers when customers, humans, robots, or persons choose interactive payment alternatives over traditional payment methods during order placement.

A method or system highlighting Enhanced Customer Feedback:

Feedback Integration: The process integrates a feedback mechanism that enables users to provide feedback on their interactive payment alternative experiences during order placement, offering valuable insights for advertisers, service providers, and human representatives.

A method or system reiterating User Flexibility:

User Flexibility: This disclosure emphasizes that the process accommodates various users and provides them with flexibility in choosing between traditional payment methods and interactive payment alternatives during order placement, enhancing their overall ordering experience and engagement.

A method or system for a Computing Process for Interactive Service or Product Ordering:

Interactive Ordering Alternatives: This disclosure encompasses the disclosed computing process, allowing customers, humans, robots, or persons to actively engage with interactive advertisements, human representatives, or live persons on a computing device, such as their personal device, during the service or product ordering process as an alternative to traditional payment methods.
b. Real-Time Interaction: The process enables real-time interaction between users and interactive ads, human representatives, or live persons, enhancing the service or product ordering experience.
c. Ordering Alternative Selection: Users have the option to select interactive ordering alternatives, which may include answering questions, participating in surveys, watching ads, or engaging in other interactive activities as a means of ordering services or products instead of using conventional payment methods.

A method or system emphasizing User Choice in Ordering Alternatives during Service or Product Ordering:

Ordering Choice: This disclosure outlines the process's capability to allow users to choose from various ordering alternatives, including engagement with interactive advertisements, human representatives, or live persons, that align with their preferences, interests, or demographics when ordering services or products instead of using conventional ordering methods.

A method or system underscoring Real-Time Feedback and Evaluation Mechanism:

Feedback Mechanism: This part of the disclosure emphasizes the incorporation of a real-time feedback and evaluation mechanism within the process, which collects and analyzes user feedback, ratings, and comments related to the interactive ordering alternatives during service or product ordering.

A method or system related to Privacy and User Consent:

Privacy Measures: This disclosure specifies the implementation of privacy measures to ensure user data and personal device usage adhere to applicable privacy regulations and consent standards when opting for interactive ordering alternatives during service or product ordering.

A method or system concerning Device Compatibility:

Device Compatibility: This disclosure highlights that the process is compatible with a wide range of personal devices, including smartphones, tablets, wearables, and other mobile computing devices, allowing users to participate in interactive ordering alternatives regardless of their chosen device.

A method or system reiterating the Multifunctionality of the Interactive Ordering Process:

Multifunctionality: This disclosure reiterates that the interactive computing process is multifunctional during service or product ordering, serving as a platform not only for ordering alternatives but also for feedback collection, evaluation, and engagement with advertisements, human representatives, or live persons.

A method or system focusing on Compensation and Transaction Settlement:

Compensation Mechanism: This disclosure outlines the compensation mechanism for service providers, advertisers, or sellers when customers, humans, robots, or persons choose interactive ordering alternatives over traditional payment methods during service or product ordering.

A method or system highlighting Enhanced Customer Feedback:

Feedback Integration: The process integrates a feedback mechanism that enables users to provide feedback on their interactive ordering alternative experiences during service or product ordering, offering valuable insights for advertisers, service providers, and human representatives.

A method or system reiterating User Flexibility:

User Flexibility: This disclosure emphasizes that the process accommodates various users and provides them with flexibility in choosing between traditional ordering methods and interactive ordering alternatives during service or product ordering, enhancing their overall ordering experience and engagement.

A method or system for a Computing Process for Work-Based Exchange of Value:

Work-Based Exchange System: This disclosure encompasses the disclosed computing process, allowing customers, humans, robots, or persons to engage in work or tasks for a company or entity in exchange for the value of a service or product on a computing device, such as their personal device, during the service or product ordering process as an alternative to traditional payment methods.
b. Task Assignment and Compensation: The process facilitates the assignment of tasks or work to users, along with compensation or value exchange in the form of the desired service or product, aligning with their preferences, interests, or demographics when ordering services or products instead of using conventional payment methods.

A method or system emphasizing User Choice in Value Exchange during Service or Product Ordering:

Value Exchange Choice: This disclosure outlines the process's capability to allow users to choose from various work-based value exchange opportunities, including completing tasks, providing services, or engaging in specific work activities that contribute to their desired service or product in lieu of conventional payment methods during service or product ordering.

A method or system highlighting Task Assignment and Tracking Mechanism:

Task Assignment Mechanism: This part of the disclosure emphasizes the incorporation of a task assignment and tracking mechanism within the process, enabling the assignment, monitoring, and completion tracking of tasks or work activities in exchange for the desired service or product.

A method or system related to User Verification and Authentication:

User Verification Measures: This disclosure specifies the implementation of user verification and authentication measures to ensure the identity and eligibility of users engaging in work-based value exchange activities during service or product ordering.

A method or system concerning Compensation and Transaction Settlement:

Compensation Mechanism: This disclosure outlines the compensation mechanism for users who engage in work-based value exchange activities, ensuring the equitable exchange of their labor or tasks for the desired service or product.

A method or system reiterating Multifunctionality of the Work-Based Exchange Process:

Multifunctionality: This disclosure reiterates that the work-based exchange computing process is multifunctional during service or product ordering, serving as a platform not only for value exchange but also for task assignment, tracking, and user engagement.

A method or system focusing on Enhanced User Engagement:
a. Engagement Integration: The process integrates an engagement mechanism that enhances user engagement with work-based value exchange opportunities during service or product ordering, contributing to a richer and more interactive ordering experience.

A method or system highlighting Company or Entity Coordination:

Company or Entity Integration: This disclosure underscores the collaboration and coordination between the company or entity providing the service or product and users engaged in work-based value exchange, ensuring efficient task assignment, compensation, and service or product delivery.

A method or system reiterating User Flexibility:

User Flexibility: This disclosure emphasizes that the process accommodates various users and provides them with flexibility in choosing between traditional payment methods and work-based value exchange during service or product ordering, enhancing their overall ordering experience and engagement.

A method or system for a Computing Process for In-Person Work-Based Exchange of Value:

Work-Based Exchange System: This disclosure encompasses the disclosed computing process, which enables customers, humans, robots, or persons to work in person for a company or entity in exchange for the value of a service or product. In some embodiment, the process utilizes a computing device, such as a personal device, for verifying and tracking work progress during the ordering of services or products, providing an alternative to traditional payment methods.
b. Task Assignment and Compensation: The process facilitates the assignment of in-person tasks or work to users, along with compensation or value exchange in the form of the desired service or product, aligned with their preferences, interests, or demographics when ordering services or products instead of using conventional payment methods.

A method or system emphasizing User Choice in Value Exchange during Service or Product Ordering:

Value Exchange Choice: This disclosure outlines the process's capability to allow users to choose from various in-person work-based value exchange opportunities, including performing tasks, offering services, or engaging in specific work activities that contribute to their desired service or product instead of using conventional payment methods during service or product ordering.

A method or system highlighting Task Assignment and Tracking Mechanism:

Task Assignment Mechanism: This part of the disclosure emphasizes the incorporation of a task assignment and tracking mechanism within the process, enabling the assignment, monitoring, and progress tracking of in-person tasks or work activities in exchange for the desired service or product.

A method or system related to User Verification and Authentication:

User Verification Measures: This disclosure specifies the implementation of user verification and authentication measures to ensure the identity and eligibility of users engaging in in-person work-based value exchange activities during service or product ordering.

A method or system concerning Compensation and Transaction Settlement:

Compensation Mechanism: This disclosure outlines the compensation mechanism for users who engage in in-person work-based value exchange activities, ensuring the equitable exchange of their labor or tasks for the desired service or product.

A method or system reiterating Multifunctionality of the Work-Based Exchange Process:

Multifunctionality: This disclosure reiterates that the in-person work-based exchange computing process is multifunctional during service or product ordering, serving as a platform not only for value exchange but also for task assignment, tracking, and user engagement.

A method or system focusing on Enhanced User Engagement:

Engagement Integration: The process integrates an engagement mechanism that enhances user engagement with in-person work-based value exchange opportunities during service or product ordering, contributing to a richer and more interactive ordering experience.

A method or system highlighting Company or Entity Coordination:

Company or Entity Integration: This disclosure underscores the collaboration and coordination between the company or entity providing the service or product and users engaged in in-person work-based value exchange, ensuring efficient task assignment, compensation, and service or product delivery.

A method or system reiterating User Flexibility:

User Flexibility: This disclosure emphasizes that the process accommodates various users and provides them with flexibility in choosing between traditional payment methods and in-person work-based value exchange during service or product ordering, enhancing their overall ordering experience and engagement.

A method or system for a Computing Process for In-Person Work-Based Exchange of Value when Lacking Sufficient Funds:

Work-Based Exchange System: This disclosure encompasses the disclosed computing process, enabling customers, humans, robots, or persons facing financial constraints or lacking sufficient funds to work in person for a company or entity in exchange for the value of a service or product. In some embodiment, the process utilizes a computing device, such as a personal device, for verifying and tracking work progress, serving as a viable alternative to traditional payment methods when individuals have insufficient funds for payment.

A method or system emphasizing User's Economic Circumstances:

Economic Constraints: This part of the disclosure highlights the capability of the process to consider the economic circumstances of users, allowing them to engage in in-person work-based value exchange opportunities when they are unable to make monetary payments for desired services or products.

A method or system related to Task Assignment and Progress Monitoring:

Task Assignment Mechanism: This disclosure specifies the incorporation of a task assignment and progress monitoring mechanism within the process, facilitating the assignment, supervision, and tracking of in-person tasks or work activities in exchange for the desired service or product when users face financial limitations.

A method or system concerning User Verification and Authentication:

User Verification Measures: This disclosure outlines the implementation of user verification and authentication measures to ensure the identity and eligibility of users engaging in in-person work-based value exchange activities when they lack sufficient funds for traditional payments.

A method or system focusing on Compensation and Transaction Settlement:

Compensation Mechanism: This disclosure details the compensation mechanism for users participating in in-person work-based value exchange activities, ensuring equitable exchange of their labor or tasks for the desired service or product, particularly when financial constraints are a factor.

A method or system reiterating Multifunctionality of the Work-Based Exchange Process:

Multifunctionality: This disclosure reiterates that the in-person work-based exchange computing process is multifunctional, serving as a platform not only for value exchange but also for task assignment, monitoring, and user engagement, with a specific emphasis on accommodating users facing financial limitations.

A method or system highlighting Enhanced User Engagement:

Engagement Integration: The process integrates an engagement mechanism that enhances user engagement with in-person work-based value exchange opportunities, contributing to a more interactive and inclusive approach for users with financial constraints.

A method or system underscoring Company or Entity Coordination:

Company or Entity Integration: This disclosure underscores the collaboration and coordination between the company or entity offering the service or product and users engaged in in-person work-based value exchange, ensuring efficient task assignment, compensation, and service or product delivery, particularly for users with financial limitations.

A method or system reiterating User Empowerment:

User Empowerment: This disclosure emphasizes that the process empowers users by providing them with an alternative means of accessing desired services or products when they are unable to make traditional payments due to financial constraints, fostering a sense of inclusivity and economic participation.

A method or system for a Computing Process for Remote Work-Based Exchange of Value When Lacking Sufficient Funds:

Remote Work-Based Exchange System: This disclosure encompasses the disclosed computing process, enabling customers, humans, robots, or persons facing financial constraints or lacking sufficient funds to work remotely for a company or entity. In some embodiment, the process leverages computing devices, including personal devices, for verifying and tracking work progress. It serves as a viable alternative to traditional payment methods when individuals have insufficient funds for payment

A method or system emphasizing User's Economic Circumstances:

Economic Constraints: This part of the disclosure highlights the capability of the process to consider the economic circumstances of users, allowing them to engage in remote work-based value exchange opportunities when they are unable to make monetary payments for desired services or products.

A method or system related to Task Assignment and Progress Monitoring:

Task Assignment Mechanism: This disclosure specifies the incorporation of a task assignment and progress monitoring mechanism within the process, facilitating the assignment, supervision, and tracking of remote work tasks or activities in exchange for the desired service or product when users face financial limitations.

A method or system concerning User Verification and Authentication:

User Verification Measures: This disclosure outlines the implementation of user verification and authentication measures to ensure the identity and eligibility of users engaging in remote work-based value exchange activities when they lack sufficient funds for traditional payments.

A method or system focusing on Compensation and Transaction Settlement:

Compensation Mechanism: This disclosure details the compensation mechanism for users participating in remote work-based value exchange activities, ensuring equitable exchange of their labor or tasks for the desired service or product, particularly when financial constraints are a factor.

A method or system reiterating Multifunctionality of the Work-Based Exchange Process:

Multifunctionality: This disclosure reiterates that the remote work-based exchange computing process is multifunctional, serving as a platform not only for value exchange but also for task assignment, monitoring, and user engagement, with a specific emphasis on accommodating users facing financial limitations.

A method or system highlighting Enhanced User Engagement:

Engagement Integration: The process integrates an engagement mechanism that enhances user engagement with remote work-based value exchange opportunities, contributing to a more interactive and inclusive approach for users with financial constraints.

A method or system underscoring Company or Entity Coordination:

Company or Entity Integration: This disclosure underscores the collaboration and coordination between the company or entity offering the service or product and users engaged in remote work-based value exchange, ensuring efficient task assignment, compensation, and service or product delivery, particularly for users with financial limitations.

A method or system reiterating User Empowerment:

User Empowerment: This disclosure emphasizes that the process empowers users by providing them with an alternative means of accessing desired services or products when they are unable to make traditional payments due to financial constraints, fostering a sense of inclusivity and economic participation, all facilitated through their personal or work computing devices.

A software system for box assessment and categorization comprising:

Inspection Process: The system initiates an inspection process for each box, employing either human inspection, robot inspection, computing software, or AI to evaluate and rate the box on a scale.
b. Reusability Rating: The rating scale may include one side indicating that the box is immediately reusable for packaging purposes.
c. Non-reusability Rating: The opposite side of the rating scale signifies that the box is deemed not reusable for packaging purposes.
d. Handling of Non-reusable Boxes: In cases where the box receives a non-reusability rating, the system provides options for processing, which may include accommodating used or dirty items, recycling, or routing the box for third-party processing.

The software system as described in this disclosure, wherein the inspection process employs advanced AI computing operations for image recognition and box condition assessment, ensuring objective and accurate ratings.

The software system as described in this disclosure, wherein the rating scale may include multiple rating levels to capture varying degrees of box condition, enabling precise categorization.

The software system as described in this disclosure, wherein the system offers recommendations or instructions for handling non-reusable boxes based on their assessed condition, promoting responsible recycling or reprocessing practices.

The software system as described in this disclosure, further comprising a data analytics component that analyzes inspection data over time, facilitating improvements in the box quality assessment process and supporting sustainability goals.

The software system as described in this disclosure, wherein the system may include integration with external third-party processes or recycling facilities, ensuring proper handling and processing of non-reusable boxes in an environmentally responsible manner.

A software system for box recovery and resale, comprising:

Box Pickup Process: The system initiates a process for picking up folded boxes from residences or businesses following package deliveries, preserving the box in its folded or box form state.
b. Business Identification: The system identifies the business that originally dropped off the item in the box, establishing a link between the box and the business.
c. Box Resale Mechanism: Utilizing the identified business information, the system facilitates the sale of the recovered box back to the originating business, promoting sustainability and reusability.

The software system as described in this disclosure, wherein the box pickup process may include scheduling, tracking, and logistics management features to efficiently recover folded boxes from multiple locations.

The software system as described in this disclosure, wherein the business identification process employs data matching techniques to ensure accurate linking of each box with its respective originating business.

The software system as described in this disclosure, wherein the box resale mechanism involves establishing a marketplace or platform for businesses to repurchase folded boxes, reducing waste and promoting eco-friendly packaging practices.

The software system as described in this disclosure, wherein the system may include a feedback and rating system allowing businesses and users to rate and review the condition and usability of recovered boxes, enhancing transparency and trust in the box resale process.

The software system as described in this disclosure, further comprising a financial transaction module to facilitate secure and efficient payment transactions between businesses and the system for the repurchase of folded boxes.

A software system for managing boxes and products, comprising:

Analysis Capability: The system employs artificial intelligence (AI), a human operator, or a scanner to analyze items, boxes, and products, with the capability to obtain data or insert data into an application or computing system.
b. Data Utilization: Utilizing the obtained data, the system can notify third parties or connected computing data users, enhancing data-driven decision-making and communication.
c. Box Resale: The software platform offers the option to sell boxes from retail stores back to the original sender business of the box.
d. Recycling or Resale Options: The system provides the flexibility to sell boxes to a ‘recyclable box or cardboard place’ or any third-party buyer, offering the potential for partial or full payment for the box.
e. Condition Variability: Boxes may be returned or resold in various conditions, including crushed or folded states.

The software system as described in this disclosure, wherein the analysis capability employs advanced AI computing operations to recognize and categorize items, boxes, and products, enabling comprehensive data extraction and insertion.

The software system as described in this disclosure, wherein the data utilization may include real-time notifications to third parties or connected computing data users, ensuring timely sharing of pertinent information.

The software system as described in this disclosure, wherein the resale of boxes may include a structured process for assessing box condition, determining resale value, and facilitating the sale transaction.

The software system as described in this disclosure, wherein the recycling or resale options extend to multiple potential buyers, including third-party purchasers, recyclers, or any entity interested in folded or crushed boxes.

The software system as described in this disclosure, wherein the system employs advanced image recognition technology to analyze and assess the condition of returned boxes, whether crushed, folded, or in other states, streamlining the resale or recycling process.

A software system for managing box returns and promoting in-person locations, comprising:

Dynamic Location Management: The system allows for the dynamic change of box return drop-off, pickup, or in-person locations.
b. Retailer Notification: The system facilitates communication between retailers and the application or business, either manually or automatically, to notify of location changes, create business incentives, or establish deals.
c. Promotion and Incentive Mechanism: The application or software, either manually or automatically, promotes the specified in-person locations to consumers, registered users, email addresses, or businesses.
d. Benefit Offering: In return for box returns to the designated in-person locations, the application or software offers incentives, discounts, coupons, or credits to user accounts or shopping credits within the specified retail location or any retail location of the associated business or entity.

The software system as described in this disclosure, wherein the dynamic location management may include the ability to update and modify the box return locations in real-time, ensuring flexibility and adaptability to changing circumstances.

The software system as described in this disclosure, wherein the retailer's communication with the application or software may include manual notifications, automated notifications through the application or software, or direct integration with the system.

The software system as described in this disclosure, wherein the promotion and incentive mechanism is customized based on user preferences, purchase history, or loyalty program status, providing personalized benefits to consumers.

The software system as described in this disclosure, wherein the benefit offering may include the automatic addition of incentives, discounts, coupons, or credits to user accounts or the issuance of unique codes or QR codes for redemption within the specified retail location or any retail location of the associated business or entity.

The software system as described in this disclosure, further comprising a reporting and analytics feature that enables retailers to track the effectiveness of their promotions and incentives, allowing for data-driven decision-making and refinement of marketing strategies.

A software system for managing box returns and redemptions, comprising:

An application for users to initiate box returns or deliveries at specific retail or partner locations.
b. In some embodiment, a scanning functionality within the application that enables users to scan a specified code or QR code at the designated retail or partner location.
c. In some embodiment, a discount, credit, or coupon management system that automatically adds the corresponding benefit to the user's application upon successful scanning.
d. In some embodiment, a code generation component that generates a unique code or QR code within the application to signify the user's entitlement to the added credit, discount, or coupon.
e. In some embodiment, a redemption interface within the application that allows users to redeem the added credit, discount, or coupon through the retailer by presenting the specified code or QR code.

The software system as described in this disclosure, wherein the scanning functionality further may include the capability to verify the user's location to ensure they are at the designated retail or partner location before enabling scanning and adding benefits to the application.

The software system as described in this disclosure, wherein the discount, credit, or coupon management system is configured to personalize the benefits added to the user's application based on user preferences, purchase history, or loyalty program status.

The software system as described in this disclosure, wherein the code generation component generates time-limited codes or QR codes that expire after a predetermined period, thereby encouraging prompt redemption by users.

The software system as described in this disclosure, further comprising a notification feature that sends alerts to the user's application to inform them of the added credit, discount, or coupon and its expiration date.

The software system as described in this disclosure, wherein the application provides a user-friendly interface for users to view, track, and manage their added credits, discounts, or coupons, including redemption history and remaining balances.

Computer-Implemented Method for Utilizing Artificial Intelligence in an App for Scanning, Viewing, or Inserting Data Related to Items

User Input Reception: The method involves receiving user input through a mobile application. In some embodiment, this input indicates the user's intent to scan, view, or insert data related to an item.

Image or Video Capture: The mobile application captures an image or video of the item using the mobile device's camera.

In some embodiment, artificial Intelligence Analysis: Artificial intelligence computing operations are employed to analyze the captured image or video. In some embodiment, these computing operations identify the item and extract relevant data, including text, product details, or characteristics.

Data Display: The extracted data is displayed to the user within the mobile application.

### Method with Additional Features

User Confirmation and Correction: In addition to the steps outlined in this disclosure, this method allows the user to confirm or correct the extracted data displayed within the mobile application. In some embodiment, any corrections made by the user are stored in a database for future reference or use, ensuring accuracy.

### Method with Specific Artificial Intelligence Computing Operations

In some embodiment, AI Computing operation Specification: This method specifies that the artificial intelligence computing operations employed comprise machine learning models trained to recognize and classify items based on visual characteristics. It also may include natural language processing models for text extraction, enhancing the accuracy of data extraction.

### Computer-Implemented System for Utilizing Artificial Intelligence in an App for Scanning, Viewing, or Inserting Data Related to Items

Mobile Application: The computer-implemented system comprises a mobile application running on a user's mobile device. In some embodiment, this application is configured to receive user input, capture images or videos of items, and facilitate user interactions.

Server System: In communication with the mobile application, a server system is integrated. In some embodiment, this server system is equipped with artificial intelligence computing operations to analyze captured images or videos, identify items, and extract relevant data. It also manages the overall system operation.

User Interface Component: Within the mobile application, a user interface component is included. In some embodiment, this component displays the extracted data to the user, providing a user-friendly experience.

Database: The system incorporates a database for storing extracted data and user corrections. In some embodiment, this database ensures data accuracy and allows for future reference or utilization.

### System with Additional Features

Machine Learning Model Repository: The system may include a repository of machine learning models within the server system. In some embodiment, these pre-trained models are specifically designed for item recognition and natural language processing, enhancing the capabilities of the artificial intelligence computing operations.

Data Storage Module: A data storage module within the server system is utilized to store historical data and user corrections. In some embodiment, this data storage facilitates continuous improvement of the accuracy of the artificial intelligence computing operations.

### System with Augmented Reality Integration

In some embodiment, augmented Reality Utilization: In addition to the features outlined in any of the embodiments described in this disclosure, the mobile application is configured to utilize augmented reality technology. In some embodiment, this technology overlays the extracted data onto the captured image or video in real time, providing a user-friendly interface for viewing item information. In some embodiment, this enhances the user experience by presenting data in a visually intuitive manner.

A computer-implemented method for facilitating item returns to a physical retail store, comprising:

Receiving, via a mobile application, input from a user indicating their intent to return an item to a specific physical retail store location;

Determining the location of the user's mobile device;

Identifying the nearest physical retail store location of the specified store based on the determined location of the user's mobile device;

Providing the user with return instructions, including store location, return policy, and any required documentation for the identified nearest physical retail store;

Generating a return authorization barcode or QR code within the mobile application for the identified nearest physical retail store;

Transmitting the generated barcode or QR code to the user's mobile device;

In some embodiment, allowing the user to present the generated barcode or QR code at the identified nearest physical retail store for processing the return of the item.

The method as described in this disclosure, further comprising:

Receiving, via the mobile application, information about the item to be returned, including product details, purchase date, and reason for return;

Storing the information about the item to be returned within the mobile application for reference during the return process;

Verifying the user's eligibility for return by the specified store's return policy based on the provided information about the item to be returned.

The method as described in this disclosure, further comprising:

Updating the user's account with information about the return, including return date, store location, and any refund or exchange details, upon successful completion of the return process;

Send a confirmation notification to the user's mobile device indicating that the return has been processed.

A computer-implemented system for facilitating item returns to physical retail stores, comprising:

A mobile application running on a user's mobile device, configured to receive input indicating the user's intent to return an item to a specific physical retail store location;

In some embodiment, a server system in communication with the mobile application, configured to determine the user's current location, identify the nearest physical retail store location of the specified store, and provide return instructions, including store location, return policy, and any required documentation to the mobile application;

In some embodiment, a barcode or QR code generator module within the mobile application, configured to generate a return authorization barcode or QR code for the identified nearest physical retail store;

In some embodiment, a communication module within the mobile application, configured to transmit the generated barcode or QR code to the user's mobile device;

In some embodiment, a barcode or QR code reader at the identified nearest physical retail store configured to scan the generated barcode or QR code presented by the user to process the item's return.

The system as described in this disclosure, further comprising:

In some embodiment, a database for storing information about items to be returned, including product details, purchase date, and reason for return;

In some embodiment, a verification module within the server system, configured to verify the user's eligibility for return by the specified store's return policy based on the information about the item to be returned stored in the database.

The system as described in this disclosure, further comprising:

In some embodiment, a n account management module within the server system, configured to update the user's account with information about the return, including return date, store location, and any refund or exchange details, upon successful completion of the return process;

A notification module within the server system is configured to send a confirmation notification to the user's mobile device indicating that the return has been processed.

A computer-implemented method for scheduling item pickups or returns, comprising:

Receiving, via a mobile application, input from a user specifying the details of an item pickup or return, including the date, time, location, and item information;
b. Storing the received information about the scheduled item pickup or return;
c. Communicating the scheduled pickup or return details to a logistics system for coordination;
d. Sending confirmation notifications to the user and relevant service providers confirming the scheduled pickup or return.

The method as described in this disclosure, further comprising:
e. Providing the user with a real-time tracking feature within the mobile application to monitor the status and location of the scheduled item pickup or return;
f. In some embodiment, allowing the user to make changes to the scheduled pickup or return, including rescheduling or canceling, via the mobile application.

The method as described in this disclosure, further comprising:
g. Utilizing location-based services to determine the user's current location and automatically pre-fill pickup or return location fields within the mobile application to streamline the scheduling process.

A computer-implemented system for scheduling item pickups or returns, comprising:

A mobile application running on a user's mobile device, configured to receive and store input specifying the details of an item pickup or return and communicate these details to a logistics system;
b. In some embodiment, a server system in communication with the mobile application and the logistics system, configured to store and manage the scheduling information and generate confirmation notifications for users and service providers;
c. In some embodiment, a real-time tracking module within the mobile application, configured to provide users with status and location updates of the scheduled item pickup or return;
d. In some embodiment, a user interface component within the mobile application, allowing users to make changes to scheduled pickups or returns.

The system as described in this disclosure, further comprising:
e. In some embodiment, a location-based services module within the mobile application, configured to determine the user's current location and pre-fill pickup or return location fields to facilitate scheduling.

The system as described in this disclosure, wherein the logistics system is further configured to:
f. In some embodiment, assign and dispatch pickup or return requests to designated service providers based on the scheduling information received from the mobile application;
g. Provide service providers access to scheduling information and navigation instructions to facilitate item pickups or returns.

A computer-implemented method for utilizing artificial intelligence in an app for scanning, viewing, or inserting data related to items comprising:

Receiving, via a mobile application, user input indicating an intent to scan, view, or insert data about an item;
b. Capturing an image or video of the item using the mobile device's camera;
c. Utilizing artificial intelligence computing operations to analyze the captured image or video, identify the item, and extract relevant data, including text, product details, or characteristics;
d. Displaying the extracted data to the user within the mobile application.

The method as described in this disclosure, further comprising:
e. In some embodiment, a allowing the user to confirm or correct the extracted data displayed within the mobile application;
f. Storing the corrected data in a database for future reference or use.

The method as described in this disclosure, wherein the artificial intelligence computing operations comprise:
g. Machine learning models trained to recognize and classify items based on visual characteristics and natural language processing models for text extraction.

A computer-implemented system for utilizing artificial intelligence in an app for scanning, viewing, or inserting data related to items, comprising

A mobile application running on a user's mobile device, configured to receive user input and capture images or videos of items;
b. In some embodiment, a server system in communication with the mobile application, equipped with artificial intelligence computing operations to analyze captured images or videos, identify items, and extract relevant data;
c. In some embodiment, a user interface component within the mobile application, displaying the extracted data to the user
d. In some embodiment, a database for storing extracted data and user corrections.

The system as described in this disclosure, further comprising:
e. In some embodiment, a machine learning model repository within the server system containing pre-trained models for item recognition and natural language processing;
f. In some embodiment, a data storage module within the server system, storing historical data and user corrections to improve the accuracy of the artificial intelligence computing operations.

The system as described in this disclosure, wherein the mobile application is configured to:
g. Utilize augmented reality technology to overlay extracted data onto the captured image or video in real time, providing a user-friendly interface for viewing item information.

A computing process for facilitating order placement, comprising:
a) receiving an order request from a customer on a computing device;
b) determining the availability of an advertisement viewing option associated with the order request;
c) presenting, on the computing device, an option for the customer to watch an advertisement on their personal device or another person's personal device in lieu of or in addition to traditional payment or tipping methods; and
d) upon the customer's selection of the advertisement viewing option, displaying the selected advertisement on the specified device.

The computing process as described in this disclosure, wherein the advertisement viewing option is determined based on one or more factors, including but not limited to, the nature of the order, the customer's preferences, and the available advertisements.

The computing process as described in this disclosure, wherein the advertisement viewing option further comprises an incentive system, wherein the customer receives a discount, reward, or other benefit for choosing to watch the advertisement in connection with their order.

The computing process as described in this disclosure, further comprising:
a) tracking the duration and completion of the advertisement viewed by the customer;
b) determining an appropriate credit or compensation for the customer based on the tracked information; and
c) applying the credit or compensation towards the cost of the placed order.

The computing process as described in this disclosure, wherein the advertisement viewing option is presented through a graphical user interface on the computing device, allowing the customer to seamlessly initiate and complete the advertisement viewing process.

The computing process as described in this disclosure, further comprising:
a) obtaining explicit consent from the customer to share information related to their order and advertisement viewing preferences with advertisers or third-party entities; and
b) utilizing the shared information to provide targeted and personalized advertisements to the customer during the order placement process.

The computing process as described in this disclosure, wherein the personal device on which the advertisement is viewed may include but is not limited to a smartphone, tablet, smartwatch, or any other portable electronic device capable of displaying multimedia content.

A computing system configured to perform the method of any of the embodiments described in this disclosure.

A non-transitory computer-readable storage medium storing instructions that, when executed by a processor, cause the processor to perform the method of any of the embodiments described herein.

A computing process for facilitating the purchase of a lottery ticket through a mobile device, comprising:
a) receiving a request from a user to buy a lottery ticket via a mobile application;
b) generating and providing a set of digital lottery numbers to the user's mobile device in response to the purchase request;
c) securely associating the generated digital lottery numbers with the user's account information; and
d) confirming the completion of the lottery ticket purchase transaction.

The computing process as described in this disclosure, wherein the digital lottery numbers provided to the user's mobile device are generated using a random number generation computing operation to ensure unpredictability and fairness in the lottery ticket assignment.

The computing process as described in this disclosure, further comprising:
a) presenting on the user's mobile device a graphical representation of the purchased lottery ticket, including the generated digital numbers and relevant lottery details;
b) allowing the user to customize or select specific numbers for their lottery ticket through the mobile application before finalizing the purchase.

The computing process as described in this disclosure, wherein the user's mobile device is authenticated through secure authentication methods, including but not limited to biometric authentication, PIN codes, or two-factor authentication, to ensure the security of the lottery ticket purchase transaction.

The computing process as described in this disclosure, further comprising:
a) integrating a digital wallet or payment gateway functionality into the mobile application to facilitate secure payment for the purchased lottery ticket; and
b) confirming the completion of the payment transaction before finalizing the issuance of the digital lottery numbers.

The computing process as described in this disclosure, wherein the digital lottery numbers are stored in a secure database associated with the lottery service provider, ensuring the integrity and confidentiality of the lottery ticket information.

The computing process as described in this disclosure, further comprising:
a) sending a digital confirmation receipt to the user's mobile device, providing details of the purchased lottery ticket, including date, time, and transaction confirmation information; and
b) allowing the user to access the digital confirmation receipt through the mobile application at any time.

The computing process as described in this disclosure, wherein the purchased lottery ticket is automatically entered into relevant lottery drawings or events based on the selected numbers and the lottery service provider's schedule.

A computing system configured to perform the method of any of the embodiments described in this disclosure, providing a technological framework for implementing the process of buying a lottery ticket through a mobile device and receiving digital lottery numbers.

A non-transitory computer-readable storage medium storing instructions that, when executed by a processor, cause the processor to perform the method of any of the embodiments described in this disclosure, offering a tangible and practical embodiment of the described computing process for buying lottery tickets through a mobile device.

A live lottery ticket purchasing digital process, comprising:
a) A user interacting with a digital interface to initiate a live lottery ticket purchase;
b) Displaying, on a screen, a live video feed of a gas station attendant or representative (“Gas Station Guy”) who physically acquires the lottery ticket on behalf of the user;
c) Recording the live video feed to authenticate and document the Gas Station Guy's procurement of the lottery ticket;
d) The Gas Station Guy verbally announcing the lottery ticket numbers to the user during the live video feed;
e) Generating and sending a digital receipt to the user, confirming the lottery ticket purchase; and
f) Confirming the purchase by validating that the lottery ticket was physically printed at the gas station.

The live lottery ticket purchasing digital process as described in this disclosure, wherein:
a) The digital interface may include a mobile application, a website, or any other electronic platform enabling the user to remotely participate in the live lottery ticket purchasing process.

The live lottery ticket purchasing digital process as described in this disclosure, wherein:
a) The live video feed is streamed in real-time, providing a contemporaneous and transparent experience for the user during the lottery ticket acquisition.

The live lottery ticket purchasing digital process as described in this disclosure, further comprising:
a) Verifying the identity of the Gas Station Guy through biometric authentication, secure login credentials, or other authentication means to ensure the integrity of the lottery ticket acquisition process.

The live lottery ticket purchasing digital process as described in this disclosure, wherein:
a) The digital receipt may include details such as the lottery ticket numbers, date and time of purchase, and any additional relevant information regarding the lottery ticket transaction.

The live lottery ticket purchasing digital process as described in this disclosure, wherein:
a) The confirmation of the purchase may include a verification step to ensure that the lottery ticket was successfully printed at the gas station after the live video feed interaction.

The live lottery ticket purchasing digital process as described in this disclosure, further comprising:
a) Storing the recorded live video feed and associated data in a secure database for auditing, authentication, and compliance purposes.

A computing system configured to perform the live lottery ticket purchasing digital process of any of the embodiments described in this disclosure, providing a technological infrastructure for implementing the innovative process of remotely acquiring lottery tickets with live video verification.

A non-transitory computer-readable storage medium storing instructions that, when executed by a processor, cause the processor to perform the live lottery ticket purchasing digital process of any of the embodiments described in this disclosure, offering a tangible embodiment of the described computing process for remote lottery ticket acquisition with live video verification.

A software system for gig or food delivery applications on computing devices, comprising:
a) A facial recognition module configured to capture and authenticate the facial features of an individual during the signup process;
b) A user profile associated with the authenticated facial features, linking the individual's identity to the gig or food delivery application account;
c) A user interface enabling the individual to accept orders or engage in gigs such as driving, delivering, picking up items, and other relevant activities only when the facial recognition authentication matches the registered user during the active session.

The software system as described in this disclosure, wherein:
a) The facial recognition module employs advanced facial recognition computing operations to ensure a high degree of accuracy in identifying and authenticating the individual during the signup and active session.

The software system as described in this disclosure, further comprising:
a) A real-time facial recognition verification process during each session to confirm the identity of the individual engaging in gigs or food delivery orders.

The software system as described in this disclosure, wherein:
a) The facial recognition module is integrated into a mobile application, ensuring portability and convenience for users engaging in gig or food delivery activities.

The software system as described in this disclosure, further comprising:
a) An authentication log recording facial recognition verification attempts and results for auditing, security, and compliance purposes.

The software system as described in this disclosure, wherein:
a) The user profile may include additional verification steps such as document verification or biometric authentication to enhance the overall security and authenticity of the user's identity.

The software system as described in this disclosure, wherein:
a) The gig or food delivery application may include features such as order acceptance, navigation, and communication tools, accessible only upon successful facial recognition authentication.

The software system as described in this disclosure, further comprising:
a) An alert system notifying the user and the platform administrator in case of a facial recognition mismatch or suspicious activity during gig or food delivery engagements.

The software system as described in this disclosure, wherein:
a) The facial recognition module is designed to adapt to varying environmental conditions, ensuring reliable authentication in different lighting and background scenarios.

The software system as described in this disclosure, further comprising:
a) A privacy control feature allowing the user to manage and control the storage and usage of facial recognition data in compliance with privacy regulations.
A computing system configured to execute the software system of any of the embodiments described in this disclosure, providing a technological framework for implementing the facial recognition-based identity verification for gig or food delivery applications.

A non-transitory computer-readable storage medium storing instructions that, when executed by a processor, cause the processor to perform the steps of the software system of any of the embodiments described in this disclosure, offering a tangible embodiment of the described facial recognition authentication process for gig or food delivery applications.

A software system for facilitating curbside pickup or delivery pickup for physical items, comprising:
a) A user interface enabling users to pre-order physical items for curbside pickup or delivery pickup;
b) Car recognition technology configured to identify and authenticate the approaching vehicle using visual data or other sensors;
c) GPS functionality to determine the location and proximity of the vehicle to the designated pickup point;
d) A notification system to alert store employees or service providers of the approaching vehicle, prompting them to prepare and deliver the pre-ordered items.

The software system as described in this disclosure, wherein:
a) The user interface further allows users to select a specific pickup time, ensuring timely preparation and availability of the pre-ordered items upon the vehicle's arrival.

The software system as described in this disclosure, wherein:
a) The car recognition technology utilizes image recognition computing operations or other visual identification techniques to uniquely identify and associate the approaching vehicle with the pre-ordered items.

The software system as described in this disclosure, further comprising:
a) A communication module facilitating real-time communication between the user and store employees or service providers, allowing for updates, clarifications, or special instructions related to the curbside pickup or delivery pickup.

The software system as described in this disclosure, wherein:
a) The GPS functionality is configured to provide navigation instructions to the user, directing them to the designated pickup point with optimal routing.

The software system as described in this disclosure, wherein:
a) The notification system may include alerts sent to store employees or service providers, indicating the approaching vehicle's details and the pre-ordered items, thereby enabling efficient preparation and delivery.

The software system as described in this disclosure, wherein:
a) The car recognition technology employs machine learning models to adapt and improve the accuracy of vehicle recognition over time, enhancing the system's ability to uniquely identify approaching vehicles.

The software system as described in this disclosure, further comprising:
a) A user authentication mechanism ensuring that only authorized users are able to initiate pre-orders and access the curbside pickup or delivery pickup services.

The software system as described in this disclosure, wherein:
a) The user interface provides users with the option to customize their curbside pickup or delivery pickup preferences, including but not limited to delivery to a specific car door or trunk.

The software system as described in this disclosure, wherein:
a) The notification system is configured to send notifications to the user, confirming that the pre-ordered items are ready for pickup and providing any additional instructions or information.

A computing system configured to execute the software system of any of the embodiments described in this disclosure, providing a technological infrastructure for implementing the innovative curbside pickup or delivery pickup process for physical items.

A non-transitory computer-readable storage medium storing instructions that, when executed by a processor, cause the processor to perform the steps of the software system of any of the embodiments described in this disclosure, offering a tangible embodiment of the described curbside pickup or delivery pickup process for physical items.

A method for creating a drive-through order using a mobile device, comprising:
a) Receiving an order request through a mobile application on the user's device;
b) Utilizing car recognition software to identify and authenticate the user's vehicle based on visual data or other sensors;
c) Automatically processing and preparing the drive-through order without requiring manual confirmation or alteration on the user's personal device;
d) Delivering the prepared order to the identified and authenticated vehicle upon its arrival at the drive-through location.

The method as described in this disclosure, wherein:
a) The car recognition software employs advanced image recognition computing operations or other visual identification techniques to uniquely identify the user's vehicle and associate it with the specific order details.

The method as described in this disclosure, further comprising:
a) Providing the user with real-time updates and notifications regarding the status and readiness of the drive-through order, ensuring transparency and user engagement.

The method as described in this disclosure, wherein:
a) The drive-through order is processed and prepared based on the user's historical preferences, order history, or predefined settings stored in the mobile application.

The method as described in this disclosure, wherein:
a) The car recognition software adapts and improves over time by utilizing machine learning models, enhancing its ability to accurately identify and associate vehicles with drive-through orders.

The method as described in this disclosure, wherein:
a) The user's mobile device is equipped with location-sharing functionality, providing real-time information to the drive-through system to optimize order preparation based on the vehicle's proximity to the drive-through location.

A system for implementing the method of any of the embodiments described in this disclosure, comprising:
a) A mobile application with order creation capabilities;
b) Car recognition software utilizing visual data or other sensors for identifying and authenticating vehicles;
c) A drive-through processing system configured to automatically prepare and deliver orders to recognized and authenticated vehicles.

A non-transitory computer-readable storage medium storing instructions that, when executed by a processor, cause the processor to perform the steps of the method of any of the embodiments described in this disclosure, providing a tangible embodiment of the described drive-through order creation and processing method.

A computer program product comprising computer-readable instructions stored on a non-transitory medium, wherein execution of the instructions by a processor implements the steps of the method of any of the embodiments described in this disclosure, facilitating the creation and processing of drive-through orders using car recognition technology.

A drive-through order processing system, comprising:
a) Means for receiving order requests through a mobile application;
b) Car recognition means utilizing visual data or other sensors to identify and authenticate vehicles associated with the order requests;
c) Means for automatically processing and preparing drive-through orders without requiring manual confirmation or alteration on user devices;
d) Means for delivering the prepared orders to identified and authenticated vehicles upon their arrival at the drive-through location.

The drive-through order processing system as described in this disclosure, further comprising:
a) Means for providing real-time updates and notifications to users regarding the status and readiness of their drive-through orders.

The drive-through order processing system as described in this disclosure, wherein:
a) The car recognition means incorporates advanced image recognition computing operations or other visual identification techniques to uniquely identify and associate vehicles with specific order details.

The drive-through order processing system as described in this disclosure, wherein:
a) The car recognition means adapts and improves over time by utilizing machine learning models, enhancing its accuracy in identifying and associating vehicles with drive-through orders.

The drive-through order processing system as described in this disclosure, wherein:
a) The means for automatically processing and preparing drive-through orders utilizes user preferences, order history, or predefined settings stored in the mobile application.

The drive-through order processing system as described in this disclosure, wherein:
a) The system is integrated with location-sharing functionality in user mobile devices to optimize order preparation based on the proximity of vehicles to the drive-through location.

A computing system for facilitating food transactions, comprising:
a) A user interface allowing a user to post a specified budget for a meal or food item;
b) A bidding module enabling restaurants to submit bids in response to the user's posted budget, wherein bids include details on the proposed meal or food item, such as menu items, quantity, and additional offerings;
c) A matching computing operation determining the winning bid based on the user's preferences and the submitted bids;
d) A transaction processing system executing the transaction between the user and the selected restaurant.

The computing system as described in this disclosure, wherein:
a) The user interface may include options for specifying preferences, dietary restrictions, or cuisine preferences to refine the bidding process and enhance user satisfaction.

The computing system as described in this disclosure, further comprising:
a) A recommendation engine providing suggestions to the user based on historical preferences, order history, or user profile information to assist in crafting a suitable budget.

The computing system as described in this disclosure, wherein:
a) The bidding module may include a real-time updating feature, allowing restaurants to adjust and modify their bids as needed to compete for the user's business.

The computing system as described in this disclosure, wherein:
a) The user interface provides options for the user to choose between pickup orders, dine-in, or delivery, and the bidding module adjusts bids accordingly based on the chosen mode of food service.

The computing system as described in this disclosure, further comprising:
a) A user rating and feedback system allowing users to rate and provide feedback on the quality of the meals or food items received, as well as the overall experience with the chosen restaurant.

The computing system as described in this disclosure, wherein:
a) The bidding module incorporates machine learning computing operations to analyze user preferences and bidding patterns, optimizing the matching computing operation over time to improve bid relevance and user satisfaction.

The computing system as described in this disclosure, wherein:
a) The transaction processing system may include secure payment functionality, allowing users to make payments for the selected meal or food item directly through the system.

The computing system as described in this disclosure, wherein:
a) The bidding module may include an alert system notifying users of new bids, promotions, or special offers from restaurants that match or exceed the specified budget.

A method for facilitating food transactions in a computing system, comprising:
a) Receiving a specified budget for a meal or food item from a user through a user interface;
b) Enabling restaurants to submit bids in response to the user's posted budget, the bids containing details on the proposed meal or food item;
c) Determining the winning bid based on the user's preferences and the submitted bids using a matching computing operation;
d) Executing the transaction between the user and the selected restaurant.

The method as described in this disclosure, further comprising:
a) Refining the bidding process by allowing users to specify preferences, dietary restrictions, or cuisine preferences through the user interface.

The method as described in this disclosure, further comprising:
a) Providing suggestions to the user through a recommendation engine based on historical preferences, order history, or user profile information to assist in crafting a suitable budget.

The method as described in this disclosure, further comprising:
a) Adjusting and modifying bids in real-time using a bidding module to allow restaurants to compete for the user's business.

The method as described in this disclosure, further comprising:
a) Allowing users to choose between pickup orders, dine-in, or delivery through the user interface, and adjusting bids accordingly based on the chosen mode of food service.

The method as described in this disclosure, further comprising:
a) Analyzing user preferences and bidding patterns using machine learning computing operations within the bidding module to optimize the matching computing operation over time.

The method as described in this disclosure, further comprising:
a) Notifying users of new bids, promotions, or special offers through an alert system from restaurants that match or exceed the specified budget.

In some embodiments, after a posting is made, a suggestion of attorneys may show the user that the user can pre-approve, etc. In some embodiments, an AI can accept an input of ‘type of insurance, type of care, type of care they need, how soon, distance, in person or zoom,’ etc., and then it connects to that person via artificial intelligence. In some embodiments, the AI takes the leads to a list, and then they puts them there and then shows the other person that they were looking for the people in the list and their issue, etc.

In some embodiments, the user gives input of information and selections to post or submit; the information is then put into a streamlined AI such as ‘create this post to make it 20 seconds long as a pitch to explain to someone who needs to understand this information in 20 seconds or less,’ and then it automatically creates an output of a video ai explainer, a streamlined explainer, an ai version of the input, etc. In some embodiments, for example, user inputs ‘Happened on this day at this time this way, in this state, my arm is broken, I have nerve damage, I am 40-year-old male,’ and the ai converts that into ‘medical malpractice, 6 months ago, nerve damage, Dallas, Texas, seeking representation for severe nerve damage compensation from healthcare provider XYZ, etc. or some form of a streamlined information explainer video, explainer posting, explainer ai output, etc.

In some embodiments, a computing system that scans the face and analyzes colors, shapes, lengths, styles, ethnicity, style, inputs given, instructions given, and does the makeup of the person. In some embodiments, the robotic system does the makeup, skincare, extractions, and medications, such as acne medications, creams, etc., of the person, etc. In some embodiments, an AI system combines all inputs, such as a live picture, a live video, and live streaming, and all inputs, such as ethnicity, eye length, lip length, lip color, skin color, etc. It uses the information to choose makeup foundation, lip color, lip gloss, mascara, eye shadow, style of eyeliner, blush, false lashes, etc. and does the makeup of the person, or it may use the input instructions to combine this information to create the makeup look suggested or instructed by a person as the input, or it may allow it to surprise the person or do its own makeup decisions, or it may be able to show the computing system or AI what makeup look they want. It may be able to create that makeup look using the AI, robotic system, computing system, all three or one or any combination to do the skin, makeup, lashes, creams, blushes, etc. of the person. In some embodiments, a person may put their chin on a resting plate, and the system may hold the head steady so the robotic arm or robotic apparatus may perform the entire routine or skincare or makeup or look the user or person is trying to receive, etc.

In some embodiments, Pricing is related to how many cases are on the web app, app, site, software, etc. In some embodiments, Pricing is based on each state and related to how many cases are available on the posting or there in each state; price is based on a percentage based on how many cases and how large the state or how many options, or how many leads are available to that attorney based on where they are licensed, if they are licensed in two states for example, they will be charged for each state they are licensed and how many leads are available for those two states, etc. if they want to remove leads from one state, they can remove themselves as being licensed in that state, and those cases will not be available to them from those clients, etc. In some embodiments, users can view themselves wearing a shirt, for example, from a website that they want to buy, by standing in front of a webcam or a camera or an AI visual projection, etc. In some embodiments, a Virtual wardrobe stands in front of a webcam and virtually tries on the shirt what a user wants to buy on the internet located on a website, etc. In some embodiments, a shirt doesn't have to be a shirt it can be anything for purchase, viewing it through the webcam, on a hologram, a screen, etc.

This application incorporates by reference the entireties of: U.S. application Ser. No. 18/922,360, filed on Oct. 21, 2024, U.S. application Ser. No. 18/402,659, filed on Jan. 2, 2024, U.S. Pat. No. 12,124,881, U.S. Provisional Application No. 63/436,582, filed on Dec. 31, 2022, U.S. Provisional Application No. 63/461,314, filed on Apr. 23, 2023, U.S. Provisional Application No. 63/543,101, filed on Oct. 8, 2023, and U.S. Provisional Application No. 63/546,235, filed on Oct. 29, 2023.

This application incorporates by reference the entireties of: U.S. application Ser. No. 18/916,544, filed on Oct. 15, 2024, U.S. Provisional Application No. 63/617,051, filed on Jan. 2, 2024 and U.S. Provisional Application No. 63/544,227, filed on Oct. 15, 2023.

This application incorporates by reference the entireties of: U.S. Provisional Application No. 63/613,049, filed on Dec. 20, 2023, U.S. Provisional Application No. 63/617,050, filed on Jan. 2, 2024, and U.S. Provisional Application No. 63/617,056, filed on Jan. 2, 2024.

In some embodiments, an (e.g., ai search result or an ai search or an ai-input, etc.) may result is showing items for sale and the option to purchase, view more, see reviews, see ratings, see real-life shoe size, virtually try it on, consult with a virtual wardrobe stylist, order the item, put the item on layaway, purchase the item as a gift, use crypto currency to purchase the item, use any medium of exchange to purchase it, put it on a credit card, pay with case, pay with virtual cash, save the item, transfer the item to someone else, send it to someone else, view the item with the person wearing it, view the item with the consumer wearing the item as an ai character or an ai person version of the consumer modeling the item in 3D or 2D or on the screen or on a hologram or virtual, etc.

In some embodiments, paying employees, contractors, workers, etc. in the form of company shares. in some embodiments, company shares may be distributed, managed, divided, sent to, paid, given to, donated, transferred, on auto-pay, auto-released, given, shared, divided, etc. in some embodiments, using a (e.g., platform, computing system, hologram, 3-D system, virtual system, webapp, app, etc.) to (e.g., divide, distribute, pay, give, donate, etc.) these company shares to employees, employees, contractors, workers, investors, donors, etc in some embodiments, founders, staff members, payroll distributors, managers, workers, employees to other employees or contractors, co-founder, investors, etc. may be able to use these methods to distribute shares or company split shares, or split shares, or create new shares, or issue new shares, or donate or pay shares, or give company shares to using the computing system either centralized or non-centralized, etc. in some embodiments, this may or may not include cryptocurrency, crypto may be used as a form of payment, etc. in some embodiments, founders or users or persons may be able to create their own cryptocurrency using the webapp, platform, centralized or decentralized platform and distribute the payment whether using USD, or crypto, or company shares, or methods of payment through the computing system, etc. in some embodiments, paying staff or helpers, or contractors, or employees in shares or percentage of the company or issuing shares may be able to be done and transferred immediately or autopay through the network or computing system, etc.

In some embodiments, AI search engine may be able to show all and any of the items for sale on the internet using the search terms or suggestions based on payment such as advertisements or organic search engine results, the user may be able to pay for the item or connect it directly to a 3rd party payment system such as crypto payment or USD type payments or auto pay or credit card system, etc., in some embodiments, users may have different types of options such as ‘find me something under 15 dollars with these specific details such as pink shirt long sleeve with buttons, etc.’ in some embodiments, user may have multiple options to be able to change their search engine options such as ‘find me a short sleeve version now’ etc. in some embodiments, users may be able to advertisement or advertise their product to show up in the search engine results whether showing these are advertisement results or depending on the subscription service such as ‘paid or free version’ of the search engine, etc. in some embodiments, ai top search results may be shown or ‘free version results with advertisement’ may be shown or ‘paid version with organic results’ may be shown, etc. in some embodiments, users may be able to search for any type of clothing or item that can be bought which may include ‘massages, cookies, food, groceries, tuition, school supplies, houses, cars, etc.’ in some embodiments, there may be a ‘MFA’ such as a code that user types in that allows user to purchase anything, rather than having to put in their credit card information, or 3rd party codes or 3rd party authorizations for payment, etc. in some embodiments, there may be each person having their own number in which they can purchase or make a payment from such as a unique ID that allows user to pay for anything using webapp, app, computing system, etc.

In some embodiments, an (e.g., ai search result or an ai search or an ai-input, etc.) may result is showing items for sale and the option to purchase, view more, see reviews, see ratings, see real-life shoe size, virtually try it on, consult with a virtual wardrobe stylist, order the item, put the item on layaway, purchase the item as a gift, use crypto currency to purchase the item, use any medium of exchange to purchase it, put it on a credit card, pay with case, pay with virtual cash, save the item, transfer the item to someone else, send it to someone else, view the item with the person wearing it, view the item with the consumer wearing the item as an ai character or an ai person version of the consumer modeling the item in 3D or 2D or on the screen or on a hologram or virtual, etc.

In some embodiments, pre-approved profiles such as women's preferences or users preferences on who can either see or allow to use or allow to view, or take on date, or schedule date, or pay for date, etc. profiles may be able to be pre-approved or pre-viewed, etc. in some embodiments, user may be only able to schedule dates with someone who has already been pre-approved, etc.

In some embodiments, the user may be able to put in some data such as which may include but not be limited to (e.g., pictures of users she finds attractive, pictures of people she likes, data such as types of schools, PDF documents full of requirements or data regarding dating preferences, videos such as types of hair colors or eye colors that she wants in a partner, facts regarding the preference of dater such as he/she doesn't drink or he does smoke, or videos or documents, or any type of data that may be searched or viewed or analyzed, etc.), and the search operation may be able to find users on the Internet or in a private database based on the preferences.

A computer-readable storage medium storing instructions that, when executed by a processor, cause the processor to perform the steps of the method of any of the embodiments described in this disclosure, providing a tangible embodiment of the described method for facilitating food transactions in a computing system.

The computing environment may include, but is not limited to, computing grid systems, distributed computing environments, cloud computing environment, etc. Such networked computing environments include hardware and software infrastructures configured to form a virtual organization comprised of multiple resources which may be in geographically disperse locations.

As will be appreciated by one skilled in the art, aspects of the present disclosure may be embodied as a system, method, or computer program product. Accordingly, aspects of the present disclosure may take the form of an entirely hardware embodiment, an entirely software embodiment (including firmware, resident software, micro-code, etc.), or an embodiment combining software and hardware aspects that may all generally be referred to herein as a “circuit”, “module” or “system”. Furthermore, aspects of the present disclosure may take the form of a computer program product embodied in one or more computer-readable medium(s) having computer-readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including, but not limited to, wireless, wireline, optical fiber cable, RF, etc., or any suitable combination of the foregoing.

Computer program code for carrying out operations for aspects of the present disclosure may be written in any combination of one or more programming languages, including an object-oriented programming language such as Java®, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer-implemented process such that the instructions which execute on the computer or other programmable apparatus provide processes for implementing the functions/acts specified in the flowchart and/or block diagram block or blocks.

Any transmission, reception, connection, or communication may occur using any short-range (e.g., Bluetooth, Bluetooth Low Energy, near field communication, Wi-Fi Direct, etc.) or long-range communication mechanism (e.g., Wi-Fi, cellular, etc.). Additionally or alternatively, any transmission, reception, connection, or communication may occur using wired technologies. Any transmission, reception, or communication may occur directly between systems or indirectly via one or more systems.

In some embodiments, the location of a user may be collected by including but not be limited to (e.g., satellite, router, phone, network, cell phone, pinging towers, servers, manual, automatic, AI, machine learning, 3rd party data, self-reporting, etc.)

In some embodiments, any databases, as described herein, may refer to one or more controlled content repositories.

The term signal, signals, or data may refer to a single or multiple signals which are non-transitory in nature. Any reference to a signal may be a reference to an attribute of the signal, and any reference to a signal attribute may refer to a signal associated with the signal attribute. As used herein, the term “real-time” or “dynamically” in any context may refer to any of current, immediately after, simultaneously as, substantially simultaneously as, a few microseconds later, a few milliseconds after, a few seconds subsequently, a few minutes after, a few hours after, a few days after, a period after, etc. In some embodiments, the term “modify” or “modification” may be interchangeably used with the term “transform” or “transformation.”

The present disclosure provides several critical technical advantages that may be readily apparent to one skilled in the art from the figures, descriptions, and Claims. Moreover, while specific advantages have been enumerated above, various embodiments may include all, some, or none of the listed advantages. Any sentence or statement in this disclosure may be associated with one or more embodiments. Reference numerals are provided in the specification for the first instance of an element numbered in the figures. In some embodiments, the reference numerals for the first instance of the element are also applicable to subsequent instances of the component of the specification, even though reference numerals may not be provided for the subsequent instances of the element.

While various embodiments in accordance with the disclosed principles have been described above, it should be understood that they have been presented by way of example only and are not limiting. Thus, the breadth and scope of the disclosure(s) should not be limited by any of the above-described exemplary embodiments but should be defined only in accordance with the Claims and their equivalents issued from this disclosure. Furthermore, the above advantages and features are provided in described embodiments. Still, they shall not limit the application of such issued Claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the disclosure(s) set out in any Claims that may issue from this disclosure. Specifically, a description of a technology in the “background” is not to be construed as an admission that technology is prior art to any disclosure(s) in this disclosure. Neither is the “summary” to be considered as a characterization of the disclosure(s) outlined in issued Claims. Furthermore, any reference in this disclosure to “disclosure” in the singular should not be used to argue that there is only a single point of novelty in this disclosure. Multiple disclosures may be set forth according to the limitations of the various Claims issuing from this disclosure, and such Claims accordingly define the disclosure(s), and their equivalents, that are protected thereby. In all instances, the scope of such Claims shall be considered on their own merits in light of this disclosure but should not be constrained by the headings herein. Any features or embodiments described in one section or paragraph anywhere in this disclosure, or in any reference or application incorporated by reference herein, can be combined with any other features or embodiments described in another section or paragraph anywhere in this disclosure, or in any reference or application incorporated by reference herein.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chosen and described in order to explain the principles of the disclosed subject-matter and its practical applications, to thereby enable others skilled in the art to use the technology disclosed and various embodiments with various modifications as are suited to the particular use contemplated. It is appreciated that the term optimize/optimal and its variants (e.g., efficient or optimally) may simply indicate improving, rather than the ultimate form of ‘perfection’ or the like.

Furthermore, the functions or operations described above can be implemented in digital electronic circuitry, in computer software, firmware or hardware. In particular, the disclosed techniques can be implemented using one or more computer program products. The computer program products, in some embodiments, comprises non-transitory computer-readable media comprising code configured to execute the disclosed approach. Programmable processors and computers can be included in or packaged as mobile devices according to some embodiments. The processes and logic flows can be performed by one or more programmable processors and by one or more programmable logic circuitry. General and special purpose computing devices and storage devices can be interconnected through communication networks.

It will also be understood that, although the terms first, second, etc., may be used herein to describe various elements, these elements should not be limited by these terms. These terms are used to distinguish one element from another. For example, a first object or step could be termed a second object or step, and, similarly, a second object or step could be termed a first object or step, without departing from the scope of the disclosure. The first object or step, and the second object or step, are both objects or steps, respectively, but they are not to be considered the same object or step.

The terminology used in the description herein is for the purpose of describing particular embodiments and is not intended to be limiting. As used in the description of the disclosure and the appended Claims, the singular forms “a,” “an” and “the” are intended to include the plural forms as well, unless the context clearly indicates otherwise. It will also be understood that the term “and/or” as used herein refers to and encompasses any possible combination of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context.

Those with skill in the art will appreciate that while some terms in this disclosure may refer to absolutes, e.g., all source receiver traces, each of a plurality of objects, etc., the methods and techniques disclosed herein may also be performed on fewer than all of a given thing, e.g., performed on one or more components and/or performed on one or more source receiver traces. Accordingly, in instances in the disclosure where an absolute is used, the disclosure may also be interpreted to be referring to a subset. m to perform the methods described herein. In some embodiments, a system may comprise one or more physical housings that include various units, such as those illustrated in FIG. 1B. In some embodiments, a chipset may be disposed in one or more housings and interfaced with one or more hardware processors. The chipset may have hardware (e.g., electronic components in an electronic circuit) for supporting various connections within the system or any other link from the system to external systems. Any embodiments, elements, features, processes, etc.) may be combined with any other embodiments, elements, features, processes, etc.) described in this disclosure (including any disclosure incorporated by reference into this disclosure). Any description in this disclosure associated with an interface, process flow, system, or embodiment may apply to one or more of any other interface, process flow, system, or embodiment.

1. A method for controlling a computing operation in a computing network, the method comprising:
providing a computing network usable by computing users registered with the computing network;
adjusting, using a resource allocator, one or more computing operations executable in the computing network, based on at least one of: a computing load associated with the computing network, an available storage or memory associated with the computing network, a number or type of users associated with the computing network or online on the computing network, or a number or type of operations being executed or to be executed by the computing network,
wherein the resource allocator is controlled by a basic input/output system (BIOS) or a resource-controlling system.
